(19) United States
(12) Patent Application Publication
(10) Pub. No.: US 2025/0313779 A1
(43) Pub. Date: Oct. 9, 2025

(54) PARTICULATE FABRIC CARE COMPOSITION

(71) Applicant: The Procter & Gamble Company, Cincinnati, OH (US)

(72) Inventors: Pu ZHAO, Beijing (CN); Kristin Rhedrick WILLIAMS, West Chester, OH (US); Hamida KHAN, Tyne and Wear (GB); Laura ORLANDINI, LE MONT-SUR-LAUSANNE (CH); Gang SI, Newcastle upon Tyne (GB); Michael MCDONNELL, Blyth (GB); Trudie Jane MCCARTHY, Newcastle upon Tyne (GB)

(21) Appl. No.: 19/173,979

(22) Filed: Apr. 9, 2025

(30) Foreign Application Priority Data
Apr. 9, 2024 (WO) PCT/CN2024/086770

(51) Int. Cl. C11D 3/37; C11D 3/00; C11D 3/50; C11D 11/00; C11D 17/06

(52) U.S. Cl. CPC C11D 3/3715; C11D 3/0036; C11D 3/3707; C11D 3/50; C11D 11/0082; C11D 17/06

(57) ABSTRACT

A particle includes from 25% to 99%, by weight of the particle, a polyalkylene glycol water-soluble carrier; and from 1.0% to 75%, by weight of the particle, a nonionic polyester soil release polymer. The nonionic polyester soil release polymer includes (a) at least one terephthalate structural unit, (b) at least one alkylene glycol structural unit, (c) at least one polyalkylene glycol structural unit comprising at least one ethylene glycol moiety. The molar ratio between (i) ethylene glycol moiety present in the polyalkylene glycol structural unit (c) to (ii) terephthalate moiety present in the terephthalate structural unit (a) is at least 5.0. The particle has a mass of from 5.0 mg to 1.0 g; the particle has a longest dimension of at least 3.0 mm; and the particle has an aspect ratio of from more than 1.1 to less than 5.0.

### TECHNICAL FIELD

The invention relates to a particle comprising a specific polyalkylene glycol water-soluble carrier and a specific nonionic polyester soil release polymer, and a through the wash laundry care additive composition comprising the particle.

### BACKGROUND

Soil release polymers are known and used in fabric and home care formulations. In the washing process, soil release polymers can deposit on fibers, which change the surface properties of fabric and deliver various benefits, such as reduced soil deposition onto fabric during wash and wear; reduced adhesion of microorganism and allergens onto fabric; easier soil removal from fabrics which treated with soil release polymer in previous wash; reduced malodor; improved wicking properties.

Laundry detergent composition comprising polyester soil release polymers are known. The chemical stability of polyester soil release polymer in liquid composition is often a challenge due to hydrolysis of the ester bonds within polyester soil release polymers in liquid composition. Water content, pH, amine (such as triethanolamine) content are known to impact the stability of polyester soil release polymers in liquid detergent composition.

Polyester soil release polymers are more stable in powder detergent, but for liquid consumers, it is not common for them to combine a powder detergent with a liquid detergent during within one wash. Therefore, to bring various benefit related soil release polymer to liquid detergent consumers, there is a need to develop through the wash laundry care additive composition comprising soil release polymers.

The inventors have surprisingly found specific nonionic polyester soil release polymers can be incorporated into a particle that comprises specific polyalkylene glycol water-soluble carrier. Said polyester soil release polymer show good compatibility with the specific making process of the particle. The particles show fast and complete dissolution into water, good appearance, and good storage stability. Through the wash laundry care additive composition comprising the particle show good on cleaning when used in combination with a detergent composition, particularly a liquid detergent composition.

### SUMMARY

In one aspect, the present disclosure is related to a particle comprising: from 25% to 99%, by weight of the particle, a polyalkylene glycol water-soluble carrier; and from 1.0% to 75%, by weight of the particle, a nonionic polyester soil release polymer;
wherein the nonionic polyester soil release polymer comprising:
   (a) at least one terephthalate structural unit,
   (b) at least one alkylene glycol structural unit,
   (c) at least one polyalkylene glycol structural unit comprising at least one ethylene glycol moiety, and
wherein the molar ratio between (i) ethylene glycol moiety present in the polyalkylene glycol structural unit (c) to (ii) terephthalate moiety present in the terephthalate structural unit (a) is at least 5.0;
wherein the particle has a mass of from 5.0 mg to 1.0 g;
wherein the particle has a longest dimension of at least 3.0 mm; and
wherein the particle has an aspect ratio of from more than 1.1 to less than 5.0.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1 shows image photos of dissolution test results for the Inventive Examples of the present disclosure vs. Comparative Examples.

### DETAILED DESCRIPTION

Features and benefits of the various embodiments of the present disclosure will become apparent from the following description, which includes examples of specific embodiments intended to give a broad representation of the invention. Various modifications will be apparent to those skilled in the art from this description and from practice of the invention. The scope of the present disclosure is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, terms such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

The term “perfume-containing particle” refers to a particle comprising one or more perfume ingredients, such as free perfumes, pro-perfumes, encapsulated perfumes (including perfume microcapsules), and the like. Preferably, such perfume-containing particles contain perfumes encapsulated in perfume microcapsules, especially friable perfume microcapsules.

The term “aspect ratio” refers to the ratio of the longest dimension of the particles over its shortest dimension. For example, when such particles have a hemispherical or compressed hemispherical shape, the aspect ratio is the ratio between the base diameter of the particles over its height.

Further, the term “substantially free of” or “substantially free from” means that the indicated material is present in the amount of from 0 wt. % to about 1 wt. %, preferably from 0 wt. % to about 0.5 wt. %, more preferably from 0 wt. % to about 0.2 wt. %. The term “essentially free of” means that the indicated material is present in the amount of from 0 wt. % to about 0.1 wt. %, preferably from 0 wt. % to about 0.01 wt. %, more preferably it is not present at analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

Since there are many tasks to be accomplished in laundering clothes such as, cleaning, stain removal, brightness, fabric restoration, softness, scent, static control, and the like, one could in theory provide a separate product for each task to be done and the consumer could completely customize the kind and amount of each benefit agent that is applied in the wash. This could become overly complicated for the consumer and require the consumer to dispense and store multiple products in his or her laundering area and combine in the optimal quantities. There are thought to be particular combinations of tasks and benefits to be obtained that the consumer might like to have available in a single product for which the dose can be customized by the consumer.

The composition described herein can provide for a through the wash particulate fabric care composition that is convenient for the consumer to dose to the washing machine. The through the wash particulate fabric care composition can be provided in a composition comprising particles. The particles described herein can be water-soluble particles. The particles can be provided in a container that is separate from the package of detergent composition. Providing the particulate fabric care composition particles in a container separate from the package of detergent composition can be beneficial since it allows the consumer to select the amount of fabric care composition independent of the amount of detergent composition used. This can give the consumer the opportunity to customize the amount of fabric care composition used and thereby the amount of fabric care benefit they achieve, which is a highly valuable consumer benefit.

Particulate products, especially particulates that are not dusty, are preferred by many consumers. Particulate products can be easily dosed by consumers from a package directly into the washing machine or into a dosing compartment on the washing machine. Or the consumer can dose from the package into a dosing cup that optionally provides one or more dosing indicia and then dose the particulates into a dosing compartment on the washing machine or directly to the drum. For products in which a dosing cup is employed, particulate products tend to be less messy than liquid products.

In one aspect, the present disclosure provides a particle comprising:
from 25% to 99%, by weight of the particle, a polyalkylene glycol water-soluble carrier; and
from 1.0% to 75%, by weight of the particle, a nonionic polyester soil release polymer;
wherein the nonionic polyester soil release polymer comprising:
   (a) at least one terephthalate structural unit,
   (b) at least one alkylene glycol structural unit,
   (c) at least one polyalkylene glycol structural unit comprising at least one ethylene glycol moiety, and
wherein the molar ratio between (i) ethylene glycol moiety present in the polyalkylene glycol structural unit (c) to (ii) terephthalate moiety present in the terephthalate structural unit (a) being at least 5.0;
wherein each of the particle has a mass of from 5.0 mg to 1.0 g;
wherein each of the particle has a longest dimension of at least 3.0 mm; and
wherein each of the particle has an aspect ratio of from more than 1.1 to less than 5.0.

In some embodiments, the particle has a mass from 5 mg to 500 mg; preferably has a mass from 5 mg to 450 mg, preferably from 10 mg to 200 mg, and more preferably from 15 mg to 150 mg. in some embodiments, the particle has a maximum dimension of more than about 3 mm and less than about 10 mm, e.g., a maximum dimension of more than 3 mm and less than 9.5 mm, preferably from 3 mm to 9 mm, more preferably from 3 mm to 8 mm. in some embodiments, the particle may have a volume from about 0.003 cm³ to about 0.15 cm³, preferably from about 0.005 cm³ to about 0.12 cm³.

Each of the particles preferably has a shape selected from the group consisting of hemispherical, compressed hemispherical, heightened hemispherical, lentil shaped, oblong, cylindrical, disc, circular, lentil-shaped, cubical, rectangular, star-shaped, flower-shaped, and any combinations thereof.

As described herein above, “aspect ratio” refers to the ratio of the longest dimension of the particles over its shortest dimension. Each of the particles of the composition in the present disclosure has an aspect ratio from 1.1 to 5.0. Preferably, each of the particle has an aspect ratio from 1.2 to 4.5, preferably from 1.5 to 4, preferably from 1.8 to 3.5. For example, in preferred embodiments, the aspect ratio of the particle is from 2.0 to 3.2.

Compressed hemispherical refers to a shape corresponding to a hemisphere that is at least partially flattened such that the curvature of the curved surface is less, on average, than the curvature of a hemisphere having the same radius. A compressed hemispherical pastille can have an aspect ratio (base diameter to height) of from 1.2 to 5.0, preferably from 2.0 to 4.5, more preferably from 2.1 to 4.

Heightened hemispherical refers to a shape corresponding to a hemisphere that is at least partially heightened such that the curvature of the curved surface is more, on average, than the curvature of a hemisphere having the same radius. A heightened hemispherical pastille can have an aspect ratio of from about more than 1.1 to less than 5.0, alternatively from about 1.2 to about 3.0, alternatively from about 1.1 to about 1.9.

Lentil shaped refers to the shape of a lentil bean. Oblong shaped refers to a shape having a maximum dimension and a maximum secondary dimension orthogonal to the maximum dimension, wherein the ratio of maximum dimension to the maximum secondary dimension is greater than about 1.2 to less than 5.0. An oblong shape can have a ratio of maximum dimension to maximum secondary dimension greater than about 1.5. An oblong shape can have a ratio of maximum dimension to maximum secondary dimension greater than about 2. Oblong shaped particles can have a maximum dimension from about 3 mm to about 6 mm, a maximum secondary dimension of from about 2 mm to about 4 mm.

In a preferred embodiment, substantially all of said particles have a substantially flat base and a height (H) measured orthogonal to said base and together said particles have a distribution of heights, wherein said distribution of heights has a mean height between 1 mm and 5 mm and a height standard deviation less than 0.3 mm.

The particles may have a density ranging from about 0.5 g/cm³ to about 1.2 g/cm³. In a preferred but not necessary embodiment of the present disclosure, the particle has a density lower than water, so that they can float on water. For example, such particles may have a density ranging from about 0.5 g/cm³ to about 0.98 g/cm³, preferably from about 0.7 g/cm³ to about 0.95 g/cm³, more preferably from about 0.8 g/cm³ to about 0.9 g/cm³.

Preferably, the particle has a mass from 5.5 mg to 450 mg, preferably from 10 mg to 200 mg, or from about 10 mg to about 125 mg or more preferably from about 20 mg to about 50 mg. The composition may comprise a plurality of particles, the average mass of each particle is from 8 mg to 450 mg, preferably from 10 mg to 200 mg, or from about 15 mg to about 125 mg or more preferably from about 20 mg to about 50 mg.

### Polyalkylene Glycol Water-Soluble Carrier

The particle of the present disclosure comprises 25% to 99% by weight of polyalkylene glycol water-soluble carrier. The polyalkylene glycol water-soluble carrier can be materials selected from polyethylene glycol, polypropethylene glycol, ethylene oxide/propylene oxide block copolymers, and combinations thereof. For example, the water-soluble carrier can be polyethylene glycol (PEG). PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

The particles can comprise about 25% to about 99% by weight of the particles of PEG. Optionally, the particles can comprise from about 35% to about 99%, optionally from about 40% to about 99%, optionally from about 50% to about 99%, optionally combinations thereof and any whole percentages or ranges of whole percentages within any of the aforementioned ranges, of PEG by weight of the respective particles. Preferably, The PEG present in the particles is characterized by a weight average molecular weight (Mw) ranging from about 2,000 to about 20,000 Daltons, optionally from about 2000 to about 15000 Da, alternatively from about 4000 to about 20000 Da, alternatively from about 4000 to about 15000 Da, alternatively from about 4000 to about 12000 Da, alternatively from about 5000 to about 11000 Da, alternatively from about 6000 to about 10000 Da, alternatively from about 7000 to about 9000 Da, alternatively combinations thereof. Suitable PEGs include homopolymers commercially available from BASF under the tradenames of Pluriol® E 8000.

Alternatively, the polyalkylene glycol water-soluble carrier can be an ethylene oxide-propylene oxide-ethylene oxide (EOx₁POyEOx₂) triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOx₁POyEOx₂) triblock copolymer has a molecular weight of from about 2000 to about 30,000 Daltons, preferably from about 3000 to about 20,000 Daltons, more preferably from about 4000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂) triblock copolymer improve cleaning.

Suitable ethylene oxide-propylene oxide-ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

The polyalkylene glycol water-soluble carrier also included “end capped” polyalkylene glycol. Typically, polyalkylene glycol has two —OH groups at both ends of the polymer chain, “end capped” means at least one or both of the —OH groups are reacted and connected to end capping organic group different from the polyalkylene glycol. Preferably, the end capping organic group R connected to the —OH groups of the polyalkylene glycol via an ether bond (—O—R) and/or ester bond (—O—(C═O)—R), where R is a linear or branched C₁-C₃₀ alkyl group, a cycloalkyl group with 5 to 9 carbon atoms, a C₆-C₃₀ arylalkyl group, a C₆-C₃₀ alkylaryl group. More preferably, R is a linear or branched C₁-C₃₀ alkyl group, even more preferably a linear C₁-C₆ alkyl group and even more preferably a methyl (CH₃).

Examples of suitable “end capped” polyalkylene glycol include a polyethylene glycol fatty alcohol ether of formula:

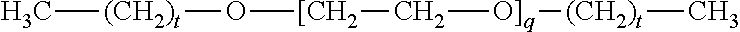

wherein
q is based on a molar average, a number from 30 to 250.
t is based on a molar average, a number from 0 to 30.

Examples of suitable “end capped” polyalkylene glycol include a polyethylene glycol fatty alcohol esters of formula:

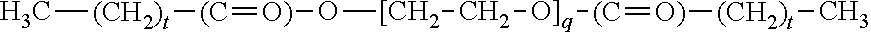

wherein
q is based on a molar average, a number from 30 to 250.
t is based on a molar average, a number from 0 to 30.

### The Nonionic Polyester Soil Release Polymer

The particle comprises 1.0 wt. % to 75 wt. %, by weight of the particle, a nonionic polyester soil release polymer. The nonionic polyester soil release polymer comprising:
(a) at least one terephthalate structural unit,
(b) at least one alkylene glycol structural unit,
(c) at least one polyalkylene glycol structural unit comprising at least one ethylene glycol moiety, and
with the molar ratio between (i) ethylene glycol moiety present in the polyalkylene glycol structural unit (c) to (ii) terephthalate moiety present in the terephthalate structural unit (a) being at least 5.0.

Preferably, the molar ratio between (i) ethylene glycol moiety present in the polyalkylene glycol structural unit (c) to (ii) terephthalate moiety present in the terephthalate structural unit (a) is in the range of from 6.0 to 100.0, more preferably from 7.0 to 50.0, more preferably 8.0 to 25.0, more preferably from 9.0 to 20.0, more preferably from 10.0 to 16.0, most preferably from 11.0 to 15.0.

Preferably, the nonionic polyester soil release polymer comprises at least one terephthalate structural unit (a), at least one alkylene glycol structural unit (b), at least one polyalkylene glycol structural unit selected from a first polyalkylene glycol structural unit (c1) and/or a second polyalkylene glycol structural unit (c2), with the structures of (a), (b), (c1) and (c2) being shown below:

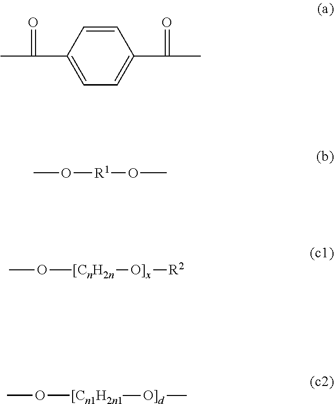

wherein,
R¹ is a linear or branched alkylene group represented by the formula (CₘH₂ₘ) wherein m is an integer from 2 to 12,
R² is a linear or branched C₁-C₃₀ alkyl group, a cycloalkyl group with from 5 to 9 carbon atoms or a C₆-C₃₀ arylalkyl group,
n is independently selected from an integer from 2 to 12,
x is, based on a molar average, a number from 2 to 200,
n1 is independently selected from an integer from 2 to 12,
d is, based on molar average, a number from 2 to 200,
wherein the polyalkylene glycol structural units (c1) and/or (c2) comprises at least one ethylene glycol moiety,
wherein the molar ratio between (i) ethylene glycol moiety present in the polyalkylene glycol structural units (c1) and (c2) to (ii) terephthalate moiety present in the terephthalate structural unit (a) is in the range of from 10 to 20.

Preferably, the nonionic polyester soil release polymer comprises at least one terephthalate structural unit (a), at least one alkylene glycol structural unit (b), at least one, preferably two, polyalkylene glycol structural unit (c1), with the structures of (a), (b), and (c1) being shown above. More preferably, the nonionic polyester soil release polymer comprises at least one terephthalate structural unit (a), at least one alkylene glycol structural unit (b), at least one polyalkylene glycol structural unit (c1), and at least one polyalkylene glycol structural unit (c2), with the structures of (a), (b), (c1) and (c2) being shown above.

Preferably, the average total molecular weight of ethylene glycol moiety present in the polyalkylene glycol structural units (c1) and (c2) in the nonionic polyester soil release polymer molecule, is from 800 to 16000, preferably from 1000 to 12000, preferably from 1600 to 10000, more preferably from 3000 to 9000, more preferably from 4000 to 8000. The average total molecular weight of ethylene glycol moiety present in the polyalkylene glycol structural units (c1) and (c2) can be calculated based the dosage of monomers used during the synthesis is the nonionic polyester soil release polymer. Those of ordinary skill in the art will understand how to calculate or measure the average total molecular weight of ethylene glycol moiety using analytical methods, such as using the integration of HNMR signals of the nonionic polyester soil release polymer combined with GPC measure of MW. The terephthalate structural unit (a):

The nonionic polyester soil release polymer comprises at least one terephthalate structural unit (a).

The terephthalate structural unit (a) is derived from terephthalic acid and/or derivatives thereof. The “derivatives thereof” comprises, without limitation, salts, esters, diesters, and/or anhydrides. Preferred ester and diester here include methyl ester, and ethyl ester. Most preferably, the terephthalate structural unit (a) is derived from dimethyl terephthalate (DMT) (CAS number: 120-61-6).

### The Alkylene Glycol Structural Unit (b):

The nonionic polyester soil release polymer comprises at least one alkylene glycol structural unit (b) as defined above

Preferably, R¹ is, each independent, a linear or branched alkylene group represented by the formula (CₘH₂ₘ) wherein m is an integer from 2 to 6, preferably from 2 to 4, more preferably 2 or 3, most preferably 3,

When the alkylene contains three or more carbon atoms, it is the intention of the present disclosure to cover all possible isomers of the alkylene, and all possible ways which the isomers connect with other structural units of the polymer. For example: alkylene group (C₃H₆) can include —CH₂—CH₂—CH₂—, —CH₂—CH(CH₃)—, and —CH(CH₃)—CH₂—; alkylene group (C₄H₈) can include —CH₂—CH₂—CH₂—CH₂—, —CH₂—CH₂—CH(CH₃)—, —CH(CH₃)—CH₂—CH₃—, —CH₂—CH(CH₃)—CH₃—, —CH(CH₃)—CH(CH₃)—, —CH₂—C(CH₃)₂—, —C(CH₃)₂—CH₂—, —CH(C₂H₅)—CH₂— and —CH₂—CH(C₂H₅)—.

Preferably, alkylene glycol structural unit (b) is each independently selected from C₂ alkylene (C₂H₄) and C₃ alkylene (C₃H₆), which include —(CH₂—CH₂)—, —CH₂—CH(CH₃)— and —CH(CH₃)—CH₂—. Most preferably, alkylene glycol structural unit (b) comprises —CH₂—CH(CH₃)— and —CH(CH₃)—CH₂—.

Preferably, the alkylene glycol structural unit (b) is derived from alkylene glycols having 2 to 6 carbon atoms. More preferably, the alkylene glycol structural unit (b) is, each independent, derived from ethylene glycol or 1,2-propylene glycol. More preferably, at least one the alkylene glycol structural unit (b) is derived from 1,2-propylene glycol.

### Polyalkylene Glycol Structural Units (c1) and (c2):

The nonionic polyester soil release polymer comprises at least one polyalkylene glycol structural unit selected from a first polyalkylene glycol structural unit (c1) and/or a second polyalkylene glycol structural unit (c2) as defined above.

The molar ratio between (i) ethylene glycol moiety present in the polyalkylene glycol structural units (c1) and (c2) to (ii) terephthalate moiety present in the terephthalate structural unit (a) is in the range of from 6.0 to 100.0, more preferably from 7.0 to 50.0, more preferably 8.0 to 25.0, more preferably from 9.0 to 20.0, more preferably from 10.0 to 16.0, most preferably from 11.0 to 15.0.

The ratio between (i) ethylene glycol moiety present in the polyalkylene glycol structural units (c1) and (c2) to (ii) terephthalate moiety present in the terephthalate structural unit (a) can be calculated based the dosage of monomers used during the synthesis is the nonionic polyester soil release polymer. Those of ordinary skill in the art will understand how to calculate the ratio using the molar number of monomers used in the preparation of the nonionic polyester soil release polymer. The ratio can also be measured using analytical methods, such as using the integration of HNMR signals of the nonionic polyester soil release polymer.

### The First Polyalkylene Glycol Structural Unit (c1):

Preferably, R² is, each independently, a linear or branched C₁-C₆ alkyl group, more preferably a linear C₁-C₄ alkyl group, more preferably C₁ alkyl group (CH₃).

Preferably, the integer n is, each independently, from 2 to 6, preferably from 2 to 4, more preferably 2 or 3, most preferably 2.

Preferably, the molar average number x, is 10 to 180, preferably from 15 to 150, preferably from 20 to 120, preferably from 25 to 100, preferably from 30 to 80, more preferably from 35 to 60, most preferably from 40 to 50.

The first polyalkylene glycol structural unit (c1) contain more than one type of [CₙH₂ₙ—O]. For example, the first polyalkylene glycol structural unit (c1) can have the following structure (c1-a):

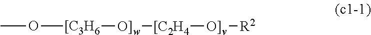

wherein,
   v and w are each independently selected from 0 to 200, and v+w=x (in structural units (c1)).
   Preferably v is from 2 to 100, more preferably from 5 to 80, more preferably from 8 to 60, and most preferably from 10 to 50.
   Preferably w is from 0 to 50, more preferably 0 to 20, more preferably from 0 to 10, and most preferably 0.

Suitable first polyalkylene glycol structural unit (c1) is derived from poly(alkylene glycol) monoalkyl ether, such as poly(ethylene glycol) monomethyl ether (mPEG). Suitable mPEG has polyethylene glycol number average molecular weight between 300 and 8000, preferably from 600 to 5000, preferably from 1000 to 4000, more preferably from 1500 to 3000, most preferably from 2000 to 2500. mPEG examples are mPEG300, mPEG550, mPEG750, mPEG1000, mPEG1500, mPEG2000, mPEG2500, mPEG3000, mPEG3500, mPEG4000, and mPEG4500.

The poly(alkylene glycol) monoalkyl ethers only have one —OH group to participate the esterification and/or transesterification reaction, therefore, the first polyalkylene glycol structural unit (c1) can only exist at the end of the polymer chain (end capping). If (c1) present, the nonionic polyester soil release polymer typically contains one or preferably two the first polyalkylene glycol structural unit (c1). The nonionic polyester soil release polymer can comprise more than two structural units (c1) when cross linking agent is used in the synthesis of the nonionic polyester soil release polymer.

The second polyalkylene glycol structural unit (c2): Preferably, the integer n1 is, each independently, from 2 to 6, preferably from 2 to 4, more preferably 2 or 3, most preferably 2.

Preferably, the molar average number d, is 4 to 180, preferably from 10 to 150, preferably from 20 to 120, preferably from 25 to 100, preferably from 30 to 80, more preferably from 35 to 60, most preferably from 40 to 50.

The polyalkylene glycol structural unit (c2) is derived from polyalkylene glycol.

Suitable polyalkylene glycol structural unit (c2) can be derived polyethylene glycol (PEG) with weight average molecular weight from 100 to 4000, preferably from 150 to 3000, preferably from 200 to 2000, more preferably from 250 to 1000.

Suitable polyalkylene glycol structural unit (c2) can be derived from random or block copolymer of ethylene oxide and propylene oxide, preferably block copolymer of ethylene oxide and propylene oxide include tri-block of EO/PO/EO or PO/EO/PO copolymers. Example of such tri-block copolymers are commercially available form BASF under tradename of Pluronic PE or Pluronic RPE, such as Pluronic PE3100, PE6100, Pluronic RPE1050.

It is understood that the nonionic polyester soil release polymer may comprises one or more type of structural unit (c-2).

Typically, polyalkylene glycols have two —OH groups to participate the esterification and/or transesterification reaction, therefore, the second polyalkylene glycol structural unit (c2) can exist in the middle, at the end of the polymer chain.

### Additional Structural Units:

Optionally, the nonionic polyester soil release polymer comprises crosslinking structural units derived from one or more crosslinking agents. Herein, the crosslinking agent is defined as an organic molecule which comprises three or more functional groups selected from carboxylic acid group; salts, esters, or anhydrides of carboxylic acid (whereby an anhydride group of carboxylic acids is equivalent to two carboxylic acid groups); hydroxyl group; and any mixture thereof. Examples of crosslinking agents comprise, but are not limited to, citric acid (contains 3 carboxylic acid groups and 1 hydroxyl group), trimellitic acid (contains 3 carboxylic acid groups), glycerol (contains 3 hydroxyl groups), and sugar alcohols such as sorbitol, mannitol, erythritol, etc.

Optionally, the nonionic polyester soil release polymer comprises structural unit derived from other dicarboxylic acids, and/or derivatives thereof. Examples of other dicarboxylic acid include, but not limit to, 2,5-furandicarboxylic acid, 1,4-cyclohexanedicarboxylic acid, adipic acid, sebacic acid, decan-1,10-dicarboxylic acid, fumaric acid, succinic acid, glutaric acid, azelaic acid, or their salts or their (di)alkyl esters, preferably their (C₁-C₄)-(di)alkyl esters and more preferably their (di)methyl esters, or mixtures thereof.

The nonionic polyester soil release polymer is essentially free of structural units contain —SO₃²⁻ group. The “essentially free” means the nonionic polyester soil release polymer comprises less than 3.0 wt. %, preferably less than 1 wt. %, preferably less than 0.2 wt. %, preferably less than 0.01 wt. %, more preferably less than 0.001 wt. % of structural units derived from monomer that comprises —SO₃²⁻ group.

A particular preferred nonionic terephthalate-derived soil release polymer has a structure according to formula below:

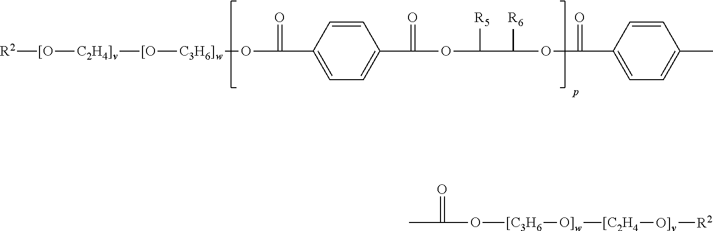

wherein:
   R₅ and R₆ is independently selected from H or CH₃. More preferably, one of the R₅ and R₆ is H, and another is CH₃.
   R₇ and R₈ is independently selected from H or CH₃. More preferably, both R₇ and R₈ are H.
      z is based on molar average, a number independently selected from 2 to 200, preferably from 5 to 100, preferably from 10 to 75, more preferably from 15 to 50, most preferably from 20 to 40.
      v, w are, based on molar average, a number independently selected from 0 to 200, where the sum of v+w is from 2 to 200,
         Preferably, w is 0 to 10, v is 10 to 150,
         More preferably, w is 0, v is 20 to 95,
         More preferably, w is 0, v is 30 to 70,
         More preferably, w is 0, v is 40 to 50,
      R² is C₁-C₄ alkyl and more preferably methyl,
      P is, based on molar average, from 1 to 20.
      Q is, based molar average, from 0 to 20.

For the preparation of the nonionic polyester soil release polymer of the invention, typically a two-stage process is used of either direct esterification of dicarboxylic acids, diols and other monomers (such as PEG and/or mPEG), or transesterification of (i) diesters of dicarboxylic acids and (ii) diols and other monomers (such as PEG and/or mPEG), followed by a polycondensation reaction under reduced pressure.

Typically, the diols (such as ethylene glycol and/or propylene glycol) is used in large excess as reactant and solvent. Without wish to be bonded by theory, large excess of diols drives the reaction equilibrium towards formation of the nonionic polyester soil release polymer and complete consumption of other monomers (dicarboxylic acids, diesters of dicarboxylic acids, PEG, mPEG, etc.). The diols can be easily removed under reduced pressure at the final stage of the polycondensation reaction, leave high purity and high active nonionic polyester soil release polymer in the reactor. Because the conversion of other monomers (dicarboxylic acids, diesters of dicarboxylic acids, PEG, mPEG, etc.) is close to complete (typically more than 95%, preferably more than 99%, more preferably more than 99.8%), those of ordinary skill in the art can calculate the ratio between (i) ethylene glycol moiety present in the polyalkylene glycol structural units (c1) and (c2) to (ii) terephthalate moiety present in the terephthalate structural unit (a) using the molar number of monomers used in the preparation of the nonionic polyester soil release polymer. The ratio can also be measured using analytical methods, such as using the integration of HNMR signals of the nonionic polyester soil release polymer. For nonionic polyester soil release polymers which are end capped (contain the first polyalkylene glycol structural unit (c1)), the average total molecular weight of ethylene glycol moiety can be calculated assuming every molar of nonionic polyester soil release polymer is end capped with two molars of first polyalkylene glycol structural unit (c1)). For nonionic polyester soil release polymers which are not end capped (does not contain the first polyalkylene glycol structural unit (c1)), the calculation of the average total molecular weight of ethylene glycol moiety can be done based on analytical measures (such as NMR and GPC).

Typical transesterification and condensation catalysts known in the art can be used for the inventive process for the preparation of the polyesters of the invention, such as antimony, germanium and titanium-based catalysts. Preferably, tetraisopropyl orthotitanate (IPT) and sodium acetate (NaOAc) are used as the catalyst system in the inventive process for the preparation of the nonionic polyester soil release polymer.

Nonionic polyester soil release polymers may be available or convert into different forms, include powder, particle, liquid, waxy or premix. For the purpose of this invention, it is preferred that the nonionic polyester soil release polymer raw material comprises less than 60 wt. %, preferrable less than 50 wt. %, preferably less than 40 wt. %, preferably less than 30 wt. %, preferably less than 20 wt. %, more preferably less than 10 wt. %, most preferably less than 1% of solvent (such as water). In situation where the nonionic polyester soil release polymer raw material comprises high level of solvent, the extra process step maybe needed to remove the solvent before making the particle of this invention.

The polyester may or may not be biodegradable, preferred soil release polymers are readily biodegradable. Preferably, the Renewable Carbon Index (RCI, a measure of sustainability by dividing the number of carbons derived from renewable sources by the total number of carbons in an active ingredient) of the polyester is above 40%, preferably above 50%, more preferably above 60%, more preferably between 70% to 100% (include 100%), and most preferably 100%.

Example of suitable nonionic soil release polymers include TexCare® SRN series supplied by Clariant, including TexCare® SRN 100, SRN 170, SRN 170 C, SRN 170 Terra, SRN 172, SRN 240, SRN 260, SRN 260 life, SRN 260 SG Terra, SRN UL50, SRN 300, SRN 325. Example of suitable nonionic soil release polymers also include REPEL-O-TEX® line of polymers supplied by Rhodia/Solvay, including nonionic soil release polymer REPEL-O-TEX® Crystal, Crystal PLUS, Crystal NAT, SRP6. Other example of commercial nonionic soil release polymers also includes WeylClean® series of soil release polymers supplied by WeylChem, including WeylClean® PLN1, PLN2. More preferred commercial nonionic soil release polymers are TexCare SRN 300, TexCare SRN260, WeylClean PLN2. Most preferred commercially available polymer is TexCare SRN300 with CAS number of 152442-40-5.

### Other Water-Soluble Carriers

The particle of the present disclosure may comprise other water-soluble carriers. The water-soluble carrier can be a material that is soluble in a wash liquor within a short period of time, for instance less than about 10 minutes.

The particle may further comprise other water-soluble carriers selected from inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, and combinations thereof.

Suitable inorganic alkali metal salts can be selected from the group consisting of sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium silicate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium silicate, and combinations thereof.

Suitable inorganic alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium silicate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium silicate, and combinations thereof.

Organic salts, such as organic alkali metal salts and organic alkaline earth metal salts, contain carbon.

Suitable organic alkali metal salts can be selected from the group consisting of sodium acetate, sodium citrate, sodium lactate, sodium tartrate, sodium ascorbate, sodium sorbate, potassium acetate, potassium citrate, potassium lactate, potassium tartrate, potassium ascorbate, potassium sorbate, and combinations thereof.

Suitable organic alkali metal salts can be selected from the group consisting of calcium acetate, calcium citrate, calcium lactate, calcium tartrate, calcium ascorbate, calcium sorbate, magnesium acetate, magnesium citrate, magnesium lactate, magnesium tartrate, magnesium ascorbate, magnesium sorbate, and combinations thereof.

Carbohydrates may be selected from the group consisting of monosaccharides, disaccharides, oligosaccharides, polysaccharides and derivatives thereof, and combinations thereof.

Suitable monosaccharides may be selected from the group consisting of erythrose, ribose, arabinose, xylose, glucose, isoglucose, dextrose, galactose, mannose, erythrulose, ribulose, fructose, sorbose, rhamnose, fucose, deoxyribose, ribose, and combinations thereof.

Suitable disaccharides sugar may be selected from the group consisting of sucrose, maltose, lactose, isomaltose, trehalose, cellobiose, melibiose, gentiobiose, and combinations thereof.

Suitable oligosaccharides maybe selected from the group consisting of maltotriose, raffinose, stachyose, and combinations thereof.

Preferably the sugar is selected from the group consisting of fructose, glucose, isoglucose, galactose, raffinose, and combinations thereof. More preferably the sugar comprises or is sucrose.

Suitable polysaccharides may be selected from the group consisting of homopolysaccharides, heteropolysaccharides, and combinations thereof.

Suitable polysaccharides may be selected from the group consisting of starch, corn starch, wheat starch, rice starch, potato starch, tapioca starch, modified starch, cellulose, carboxymethyl cellulose, methyl cellulose, ethyl cellulose, propyl cellulose, hydroxyethyl cellulose, hydroxypropyl cellulose, cellulose esters, cellulose amides, glycogen, pectin, dextrin, maltodextrin, corn syrup solids, alginates, xyloglugans, xylan, glucuronoxylan, arabinoxylan, mannan, dextran, glucomannan, galactoglucomannan, xanthan, carrageenan, locust bean gum, Arabic gum, tragacanth, and combinations thereof.

Carbohydrate derivatives may be selected from the group consisting of aminosugars, deoxysugars, sugar alcohols, sugar acids, and combinations thereof.

Suitable sugar alcohol may be selected from the group consisting of sorbitol, mannitol, isomalt, maltitol, lactitol, xylitol, erythritol, and combinations thereof. Preferably the sugar alcohol is selected from the group consisting of mannitol, sorbitol, xylitol and combinations thereof.

The water-soluble carrier may be selected from the group consisting of clay, zeolites, silica, silicates, citric acid and salts thereof, fatty alcohol, glyceryl diester of hydrogenated tallow, and combinations thereof.

The water-soluble carrier may be a water-soluble polymer selected from the group consisting of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyglycerol esters, acrylamide; polyvinyl acetates; polycarboxylic acids and salts thereof, sulfonated polyacrylates, polyaminoacids or peptides, polyamides, polyacrylamide, copolymers of maleic/acrylic acids, gelatin, and combinations thereof.

### Other Fabric Care Active Agent

The particle of the present disclosure can further comprise other fabric care active agents.

The composition comprising the particles of the present disclosure may further comprise a fabric care active agents. Preferably, the fabric care active agents is in a solid form. The fabric care active agents in a solid form can be present as a particle of any size and shape.

Suitable fabric care active agent are selected from surfactants; enzymes and enzyme stabilizers; builders; polymers selected from graft polymers based on polyalkylene oxide, modified polyamine dispersing agent, bleaching agents, bleaching catalysts, bleach activators, fluorescent brighteners, fabric hueing agents, chelating agents, encapsulates, perfume capsules, perfumes, pro-perfumes, malodor reduction materials, conditioning agents, probiotics, organic acids, anti-oxidants, anti-microbial agents and/or preservatives, hygiene agents, pearlescent agents, pigments, solvents, suds suppressor and mixtures thereof.

Preferably, the fabric care active agent is selected from the group consisting of perfume ingredients, antioxidants, enzyme, fabric softener active such as quaternary ammonium compound or silicone, cationic polymer, fatty acid, anionic surfactant and mixtures thereof.

### Perfume Ingredients

The fabric care active agent may be a free perfume, a pro-perfume, an encapsulated perfume, and a combination thereof.

The particles in the composition of the present disclosure may comprise from about 0.1 wt. % to about 20 wt. %, preferably from about 0.5 wt. % to about 15 wt. %, more preferably from about 1 wt. % to about 10 wt. % of one or more perfume ingredients, such as free perfumes, pro-perfumes, encapsulated perfumes (including perfume microcapsules), and the like.

Each particle may comprise no more than about 25%, preferably no more than about 20% (e.g., from about 0.1% to about 20%), more preferably from about 0.5% to about 15%, most preferably from about 1% to about 10%; alternatively, from about 9% to about 20%; alternatively, from about 10% to about 18%; alternatively, from about 11% to about 13%, alternatively, combinations thereof, of free perfumes by weight of such particle.

Each comprise may comprise encapsulated perfumes (i.e., perfumes carried by a carrier material such as starch, cyclodextrin, silica, zeolites or clay or in form of perfume capsules). Preferably, the particles comprise perfume oil encapsulated in core-shell perfume capsules (PMCs), which can be friable, can be moisture activated or can release perfume via diffusion.

The core-shell capsules comprise a shell surrounding a core. The shell comprises a polymeric material. The polymeric material comprises, and preferably is, the reaction product of a biopolymer and a cross-linking agent.

The biopolymer may preferably be selected from the group consisting of a polysaccharide, a protein, a nucleic acid, a polyphenolic compound, derivatives thereof, and combinations thereof. Preferably, the biopolymer is selected from the group consisting of:
(a) a polysaccharide selected from the group consisting of chitosan, starch, modified starch, dextran, maltodextrin, dextrin, cellulose, modified cellulose, hemicellulose, chitin, alginate, lignin, gum, pectin, fructan, carrageenan, agar, pullulan, suberin, cutin, cutan, melanin, silk fibronin, derivatives thereof, and combinations thereof;
(b) a protein selected from the group consisting of gelatin, collagen, casein, sericin, fibroin, whey protein, zein, soy protein, plant storage protein (plant protein isolate, plant protein concentrate), gluten, peptide, actin, derivatives thereof, and combinations thereof;
(c) a nucleic acid selected from the group consisting of polynucleotides, RNA, DNA, derivatives thereof, and combinations thereof;
(d) a polyphenolic compound selected from the group consisting of tannins, lignans, derivatives thereof, and combinations thereof; or
(e) combinations thereof.

The cross-linking agent may be selected from the group consisting of isocyanate, polyisocyanate, acyl chlorides, acrylates, methacrylate, acrylate esters, and combinations thereof.

The particles may each comprise from about 0.1% to 20.0%, preferably from about 0.5% to about 10.0%, more preferably from about 1.0% to about 5.0%, alternatively from about 4.0% to about 7.0%, alternatively from about 5.0% to about 7.0%, alternatively combinations thereof, of perfume capsules by weight of the particles.

The particle may comprise both free perfumes and encapsulated perfumes (preferably in form of perfume capsules), e.g., at a weight ratio ranging from about 1:5 to about 5:1, alternatively from about 1:4 to about 4:1, further alternatively from about 1:3 to about 3:1.

### Antioxidant

The fabric care active agent can be an antioxidant. The particles can comprise from about 0.1% to about 2% by weight antioxidant. The antioxidant can be dispersed in a matrix of said water soluble carrier. The antioxidant can those described in U.S. Patent Application 63/034,766. The antioxidant can be butylated hydroxytoluene.

### Enzyme

The fabric care active agent can be an enzyme. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, ß-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in the composition, the aforementioned additional enzymes may be present at levels from about 0.00001% to about 2%, from about 0.0001% to about 1% or even from about 0.001% to about 0.5% enzyme protein by weight of the composition.

Proteases. Preferably the composition comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), especially those derived from Bacillus, such as Bacillus sp., Bacillus sp., B. lentus, B. alkalophilus, B. subtilis, B. amyloliquefaciens, B. gibsonii, B. akibaii, B. clausii and B. clarkii described in WO2004067737, WO2015091989, WO2015091990, WO2015024739, WO2015143360, U.S. Pat. No. 6,312,936B1, U.S. Pat. Nos. 5,679,630, 4,760,025, DE102006022216A1, DE102006022224A1, WO2015089447, WO2015089441, WO2016066756, WO2016066757, WO2016069557, WO2016069563, WO2016069569, WO2017/089093, WO2020/156419.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.
(d) Protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Liquanase® Evity®, Savinase® Evity®, Ovozyme®, Neutrase®, Everlase®, Coronase®, Blaze®, Blaze Ultra®, Blaze® Evity®, Blaze® Exceed, Blaze® Pro, Esperase®, Progress® Uno, Progress® Excel, Progress® Key, Ronozyme®, Vinzon® and Het Ultra® by Novozymes A/S (Denmark); those sold under the tradename Maxatase®, Maxacal®, Maxapem®, Properase®, Purafect®, Purafect Prime®, Purafect Ox®, FN3®, FN4®, Excellase®, Ultimase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D); and KAP (Bacillus alkalophilus subtilisin with mutations A230V+S256G+S259N) from Kao and Lavergy®, Lavergy® Pro, Lavergy® C Bright from BASF.

Amylases. Preferably the composition may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.
(b) variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643:
   26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.
(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.
(d) variants exhibiting at least 95% identity with the wild-type enzyme from Bacillus sp. 707 (SEQ ID NO:7 in U.S. Pat. No. 6,093,562), especially those comprising one or more of the following mutations M202, M208, S255, R172, and/or M261. Preferably said amylase comprises one or more of M202L, M202V, M202S, M202T, M202I, M202Q, M202W, S255N and/or R172Q. Particularly preferred are those comprising the M202L or M202T mutations.
(e) variants described in WO 09/149130, preferably those exhibiting at least 90% identity with SEQ ID NO: 1 or SEQ ID NO:2 in WO 09/149130, the wild-type enzyme from Geobacillus Stearophermophilus or a truncated version thereof.
(f) variants exhibiting at least 89% identity with SEQ ID NO:1 in WO2016091688, especially those comprising deletions at positions H183+G184 and additionally one or more mutations at positions 405, 421, 422 and/or 428.
(g) variants exhibiting at least 60% amino acid sequence identity with the “PcuAmyl α-amylase” from Paenibacillus curdlanolyticus YK9 (SEQ ID NO:3 in WO2014099523).
(h) variants exhibiting at least 60% amino acid sequence identity with the “CspAmy2 amylase” from Cytophaga sp. (SEQ ID NO:1 in WO2014164777).
(i) variants exhibiting at least 85% identity with AmyE from Bacillus subtilis (SEQ ID NO:1 in WO2009149271).
(j) Variants exhibiting at least 90% identity variant with the wild-type amylase from Bacillus sp. KSM-K38 with accession number AB051102.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE® and PURASTAR OXAM® (Genencor International Inc., Palo Alto, California) and KAM® (Kao, 14-10 Nihonbashi Kayabacho, 1-chome, Chuo-ku Tokyo 103-8210, Japan). In one aspect, suitable amylases include NATALASE®, STAINZYME® and STAINZYME PLUS® and mixtures thereof.

Lipases. Preferably the composition comprises one or more lipases, including “first cycle lipases” such as those described in U.S. Pat. No. 6,939,702 B1 and US PA 2009/0217464. Preferred lipases are first-wash lipases. In one embodiment of the invention the composition comprises a first wash lipase.

First wash lipases includes a lipase which is a polypeptide having an amino acid sequence which: (a) has at least 90% identity with the wild-type lipase derived from Humicola lanuginosa strain DSM 4109; (b) compared to said wild-type lipase, comprises a substitution of an electrically neutral or negatively charged amino acid at the surface of the three-dimensional structure within 15A of E1 or Q249 with a positively charged amino acid; and (c) comprises a peptide addition at the C-terminal; and/or (d) comprises a peptide addition at the N-terminal and/or (e) meets the following limitations: i) comprises a negative amino acid in position E210 of said wild-type lipase; ii) comprises a negatively charged amino acid in the region corresponding to positions 90-101 of said wild-type lipase; and iii) comprises a neutral or negative amino acid at a position corresponding to N94 or said wild-type lipase and/or has a negative or neutral net electric charge in the region corresponding to positions 90-101 of said wild-type lipase.

Preferred are variants of the wild-type lipase from Thermomyces lanuginosus comprising one or more of the T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Other suitable lipases include: Liprl 139, e.g., as described in WO2013/171241; TfuLip2, e.g., as described in WO2011/084412 and WO2013/033318; Pseudomonas stutzeri lipase, e.g., as described in WO2018228880; Microbulbifer thermotolerans lipase, e.g., as described in WO2018228881; Sulfobacillus acidocaldarius lipase, e.g., as described in EP3299457; LIP062 lipase e.g., as described in WO2018209026; PinLip lipase e.g., as described in WO2017036901 and Absidia sp. lipase e.g., as described in WO2017005798.

Preferred lipases would include those sold under the tradenames Lipex® and Lipolex® and Lipoclean®.

Cellulases. Suitable enzymes include cellulases of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and U.S. Pat. No. 5,691,178. Suitable cellulases include the alkaline or neutral cellulases having colour care benefits. Commercially available cellulases include CELLUZYME®, CAREZYME® and CAREZYME PREMIUM (Novozymes A/S), CLAZINASE®, and PURADAX HA® (Genencor International Inc.), and KAC-500(B)® (Kao Corporation).

The bacterial cleaning cellulase may be a glycosyl hydrolase having enzymatic activity towards amorphous cellulose substrates, wherein the glycosyl hydrolase is selected from GH families 5, 7, 12, 16, 44 or 74. Suitable glycosyl hydrolases may also be selected from the group consisting of: GH family 44 glycosyl hydrolases from Paenibacillus polyxyma (wild-type) such as XYG1006 described in U.S. Pat. No. 7,361,736 or are variants thereof. GH family 12 glycosyl hydrolases from Bacillus licheniformis (wild-type) such as SEQ ID NO:1 described in U.S. Pat. No. 6,268,197 or are variants thereof; GH family 5 glycosyl hydrolases from Bacillus agaradhaerens (wild type) or variants thereof; GH family 5 glycosyl hydrolases from Paenibacillus (wild type) such as XYG1034 and XYG 1022 described in U.S. Pat. No. 6,630,340 or variants thereof; GH family 74 glycosyl hydrolases from Jonesia sp. (wild type) such as XYG1020 described in WO 2002/077242 or variants thereof; and GH family 74 glycosyl hydrolases from Trichoderma Reesei (wild type), such as the enzyme described in more detail in Sequence ID NO. 2 of U.S. Pat. No. 7,172,891, or variants thereof. Suitable bacterial cleaning cellulases are sold under the tradenames Celluclean® and Whitezyme® (Novozymes A/S, Bagsvaerd, Denmark).

The composition may comprise a fungal cleaning cellulase belonging to glycosyl hydrolase family 45 having a molecular weight of from 17 kDa to 30 kDa, for example the endoglucanases sold under the tradename Biotouch® NCD, DCC and DCL (AB Enzymes, Darmstadt, Germany). Pectate Lyases. Other preferred enzymes include pectate lyases sold under the tradenames Pectawash®, Pectaway®, Xpect® and mannanases sold under the tradenames Mannaway® (all from Novozymes A/S, Bagsvaerd, Denmark), and Purabrite® (Genencor International Inc., Palo Alto, California).

Nucleases. The composition may comprise a nuclease enzyme. The nuclease enzyme is an enzyme capable of cleaving the phosphodiester bonds between the nucleotide sub-units of nucleic acids. The nuclease enzyme herein is preferably a deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus, it includes truncated, but functional versions, of the enzyme and/or variants and/or derivatives and/or homologues whose functionality is maintained. Suitable DNases include wild-types and variants described in detail by WO2017162836 and WO2018108865, and variants of the Bacillus cibi DNase including those described in WO2018011277.

RNase: suitable RNases include wild-types and variants of DNases described in WO2018178061 and WO2020074499.

Preferably the nuclease enzyme is a deoxyribonuclease, preferably selected from any of the classes E.C. 3.1.21.x, where x=1, 2, 3, 4, 5, 6, 7, 8 or 9, E.C. 3.1.22.y where y=1, 2, 4 or 5, E.C. 3.1.30.z where z=1 or 2, E.C. 3.1.31.1 and mixtures thereof.

Hexosaminidases. The composition may comprise one or more hexosaminidases. The term hexosaminidase includes “dispersin” and the abbreviation “Dsp”, which means a polypeptide having hexosaminidase activity, EC 3.2.1.-that catalyzes the hydrolysis of β-1,6-glycosidic linkages of N-acetyl-glucosamine polymers found in soils of microbial origin. The term hexosaminidase includes polypeptides having N-acetylglucosaminidase activity and β-N-acetylglucosaminidase activity. Hexosaminidase activity may be determined according to Assay II described in WO2018184873. Suitable hexosaminidases include those disclosed in WO2017186936, WO2017186937, WO2017186943, WO2017207770, WO2018184873, WO2019086520, WO2019086528, WO2019086530, WO2019086532, WO2019086521, WO2019086526, WO2020002604, WO2020002608, WO2020007863, WO2020007875, WO2020008024, WO2020070063, WO2020070249, WO2020088957, WO2020088958 and WO2020207944. Variants of the Terribacillus saccharophilus hexosaminidase defined by SEQ ID NO: 1 of WO2020207944 may be preferred, especially the variants with improved thermostability disclosed in that publication.

Mannanases. The composition may comprise an extracellular-polymer-degrading enzyme that includes a mannanase enzyme. The term “mannanase” means a polypeptide having mannan endo-1,4-beta-mannosidase activity (EC 3.2.1.78) from the glycoside hydrolase family 26 that catalyzes the hydrolysis of 1,4-3-D-mannosidic linkages in mannans, galactomannans and glucomannans. Alternative names of mannan endo-1,4-beta-mannosidase are 1,4-3-D-mannan mannanohydrolase; endo-1,4-3-mannanase; endo-β-1,4-mannase; β-mannanase B; 3-1,4-mannan 4-mannanohydrolase; endo-3-mannanase; and -D-mannanase. For purposes of the present disclosure, mannanase activity may be determined using the Reducing End Assay as described in the experimental section of WO2015040159. Suitable examples from class EC 3.2.1.78 are described in WO2015040159, such as the mature polypeptide SEQ ID NO: 1 described therein. Galactanases. The composition may comprise an extracellular polymer-degrading enzyme that includes an endo-beta-1,6-galactanase enzyme. The term “endo-beta-1,6-galactanase” or “a polypeptide having endo-beta-1,6-galactanase activity” means an endo-beta-1,6-galactanase activity (EC 3.2.1.164) from the glycoside hydrolase family 30 that catalyzes the hydrolytic cleavage of 1,6-3-D-galactooligosaccharides with a degree of polymerization (DP) higher than 3, and their acidic derivatives with 4-O-methylglucosyluronate or glucosyluronate groups at the non-reducing terminals. For purposes of the present disclosure, endo-beta-1,6-galactanase activity is determined according to the procedure described in WO 2015185689 in Assay I. Suitable examples from class EC 3.2.1.164 are described in WO 2015185689, such as the mature polypeptide SEQ ID NO: 2.

The composition may optionally comprise from about 0.001% to about 10%, in some examples from about 0.005% to about 8%, and in other examples, from about 0.01% to about 6%, by weight of the composition, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Without wish to be bonded by theory, the combination of enzyme and the nonionic polyester soil release polymer can effectively reduce soil redeposition across different fabric types, including polyester, cotton, polycotton, polyspandex, and others used to make consumer garments.

### Quaternary Ammonium Compound

The fabric care agent can be a quaternary ammonium compound so that the composition can provide a softening or lubrication benefit to laundered fabrics.

The quaternary ammonium compound (quat) can be an ester quaternary ammonium compound. Suitable quaternary ammonium compounds include but are not limited to, materials selected from the group consisting of ester quats, amide quats, imidazoline quats, alkyl quats, amidoester quats and combinations thereof. Suitable ester quats include but are not limited to, materials selected from the group consisting of monoester quats, diester quats, triester quats and combinations thereof.

Without being bound by theory, it is thought that the cold water dissolution time of the particles that include a quaternary ammonium compound tends to decrease with increasing Iodine Value, recognizing that there is some variability with respect to this relationship.

The particles can comprise about 5% to about 45% by weight a quaternary ammonium compound. The quaternary ammonium compound can optionally have an Iodine Value from about 18 to about 60, optionally about 18 to about 56, optionally about 20 to about 60, optionally about 20 to about 56, optionally about 20 to about 42, and any whole numbers within the aforesaid ranges. Optionally the particles can comprise about 10% to about 40% by weight a quaternary ammonium compound, further optionally having any of the aforesaid ranges of Iodine Value. Optionally the particles can comprise about 20% to about 40% by weight a quaternary ammonium compound, further optionally having the aforesaid ranges of Iodine Value.

The quaternary ammonium compounds may be derived from fatty acids. The fatty acids may include saturated fatty acids and/or unsaturated fatty acids. The fatty acids may be characterized by an iodine value. The fatty acids may include an alkyl portion containing, on average by weight, from about 13 to about 22 carbon atoms, or from about 14 to about 20 carbon atoms, optionally from about 16 to about 18 carbon atoms. Suitable fatty acids may include those derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, etc.; (3) processed and/or bodied oils, such as linseed oil or tung oil via thermal, pressure, alkali-isomerization and catalytic treatments; (4) a mixture thereof, to yield saturated (e.g., stearic acid), unsaturated (e.g., oleic acid), polyunsaturated (linoleic acid), branched (e.g., isostearic acid) or cyclic (e.g., saturated or unsaturated α-disubstituted cyclopentyl or cyclohexyl derivatives of polyunsaturated acids) fatty acids.

The quaternary ammonium compound may comprise compounds formed from fatty acids that are unsaturated. The fatty acids may comprise unsaturated C18 chains, which may be include a single double bond (“C18:1”) or may be double unsaturated (“C18:2”).

The quaternary ammonium compound may be derived from fatty acids and optionally from triethanolamine, optionally unsaturated fatty acids that include eighteen carbons (“C18 fatty acids”), optionally C18 fatty acids that include a single double bone (“C18:1 fatty acids”). The quaternary ammonium compound may comprise from about 10% to about 95%, or from about 10% to about 90%, or from about 15% to about 80%, by weight of the quaternary ammonium compound, of compounds derived from triethanolamine and C18:1 fatty acids.

Suitable quaternary ammonium ester compounds may be derived from alkanolamines, for example, C1-C4 alkanolamines, optionally C2 alkanolamines (e.g., ethanolamines). The quaternary ammonium ester compounds may be derived from monoalkanolamines, dialkanolamines, trialkanolamines, or mixtures thereof, optionally monoethanolamines, diethanolamines, di-isopropanolamines, triethanolamines, or mixtures thereof. The alkanolamines from which the quaternary ammonium ester compounds are derived may be alkylated mono- or dialkanolamines, for example C1-C4 alkylated alkanolamines, optionally C1 alkylated alkanolamines (e.g., N-methyldiethanolamine).

The quaternary ammonium ester compound may comprise a quaternized nitrogen atom that is substituted, at least in part. The quaternized nitrogen atom may be substituted, at least in part, with one or more C1-C3 alkyl or C1-C3 hydroxyl alkyl groups. The quaternized nitrogen atom may be substituted, at least in part, with a moiety selected from the group consisting of methyl, ethyl, propyl, hydroxyethyl, 2-hydroxypropyl, 1-methyl-2-hydroxyethyl, poly(C₂-C₃ alkoxy), polyethoxy, benzyl, optionally methyl or hydroxyethyl.

The quaternary ammonium ester compound may comprise compounds according to Formula (I):

{R²₍₄₋ₘ₎—N+—[X—Y—R¹]ₘ}A⁻ Formula (I)
wherein:
   m is 1, 2 or 3, with provisos that, in a given molecule, the value of each m is identical, and when (a) the quaternary ammonium ester compound comprises triester quaternary ammonium material (“triester quat”), for at least some of the compounds according to Formula (I), m is 3 (i.e., a triester);
   each R¹, which may comprise from 13 to 22 carbon atoms, is independently a linear hydrocarbyl or branched hydrocarbyl group, optionally R¹ is linear, optionally R¹ is partially unsaturated linear alkyl chain;
   each R² is independently a C₁-C₃ alkyl or hydroxyalkyl group and/or each R² is selected from methyl, ethyl, propyl, hydroxyethyl, 2-hydroxypropyl, 1-methyl-2-hydroxyethyl, poly(C₂-C₃ alkoxy), polyethoxy, benzyl, optionally methyl or hydroxyethyl;
   each X is independently —(CH₂)n-, —CH₂—CH(CH₃)— or —CH(CH₃)—CH₂—, where each n is independently 1, 2, 3 or 4, optionally each n is 2;
   each Y is independently —O—(O)C— or —C(O)—O—; and
   A- is independently selected from the group consisting of chloride, bromide, methyl sulfate, ethyl sulfate, sulfate, and nitrate, optionally A- is selected from the group consisting of chloride and methyl sulfate, optionally A- is methyl sulfate.

At least one X, optionally each X, may be independently selected from —CH₂—CH(CH₃)— or —CH(CH₃)—CH₂—. When m is 2, X may be selected from *—CH₂—CH(CH₃)—, *—CH(CH₃)—CH₂—, or a mixture thereof, where the * indicates the end nearest the nitrogen of the quaternary ammonium ester compound. When there are two or more X groups present in a single compound, at least two of the X groups may be different from each other. For example, when m is 2, one X (e.g., a first X) may be *—CH₂—CH(CH₃)—, and the other X (e.g., a second X) may be *—CH(CH₃)—CH₂—, where the * indicates the end nearest the nitrogen of the quaternary ammonium ester compound. It has been found that such selections of the m index and X groups can improve the hydrolytic stability of the quaternary ammonium ester compound, and hence further improve the stability of the composition.

For similar stability reasons, the quaternary ammonium ester compound may comprise a mixture of: bis-(2-hydroxypropyl)-dimethylammonium methylsulfate fatty acid ester; (2-hydroxypropyl)-(1-methyl-2-hydroxyethyl)-dimethylammonium methylsulfate fatty acid ester; and bis-(1-methyl-2-hydroxyethyl)-dimethylammonium methylsulfate fatty acid ester; where the fatty acid esters are produced from a C12-C18 fatty acid mixture. The quaternary ammonium ester compound may comprise any of the fatty acid esters, individually or as a mixture, listed in this paragraph.

Each X may be —(CH₂)n-, where each n is independently 1, 2, 3 or 4, optionally each n is 2.

Each R¹ group may correspond to, and/or be derived from, the alkyl portion(s) of any of the fatty acids provided above. The R¹ groups may comprise, by weight average, from about 13 to about 22 carbon atoms, or from about 14 to about 20 carbon atoms, optionally from about 16 to about 18 carbon atoms. It may be that when Y is *—O—(O)C— (where the * indicates the end nearest the X moiety), the sum of carbons in each R¹ is from 13 to 21, optionally from 13 to 19.

The quaternary ammonium compounds of the present disclosure may include a mixture of quaternary ammonium compounds according to Formula (I), for example, having some compounds where m=1 (e.g., monoesters) and some compounds where m=2 (e.g., diesters). Some mixtures may even contain compounds where m=3 (e.g., triesters). The quaternary ammonium compounds may include compounds according to Formula (I), where m is 1 or 2, but not 3 (e.g., is substantially free of triesters).

The quaternary ammonium compounds of the present disclosure may include compounds according to Formula (I), wherein each R² is a methyl group. The quaternary ammonium compounds of the present disclosure may include compounds according to Formula (I), wherein at least one R², optionally wherein at least one R² is a hydroxyethyl group and at least one R² is a methyl group. For compounds according to Formula (I), m may equal 1, and only one R² may be a hydroxyethyl group.

The quaternary ammonium compounds of the present disclosure may include methyl sulfate as a counterion. When the quaternary ammonium ester compounds of the present disclosure comprise compounds according to Formula (I), A- may optionally be methyl sulfate.

The quaternary ammonium compounds of the present disclosure may comprise one or members selected from the group consisting of:
(A) bis-(2-hydroxypropyl)-dimethylammonium methylsulfate fatty acid ester and isomers of bis-(2-hydroxypropyl)-dimethylammonium methylsulfate fatty acid ester and/or mixtures thereof; N,N-bis-(2-(acyl-oxy)-propyl)-N,N-dimethylammonium methylsulfate and/or N-(2-(acyl-oxy)-propyl)N-(2-(acyl-oxy) 1-methyl-ethyl) N,N-dimethylammonium methylsulfate and/or mixtures thereof, in which the acyl moiety is derived from c12-c22 fatty acids such as Palm, Tallow, Canola and/or other suitable fatty acids, which can be fractionated and/or hydrogenated, and/or mixtures thereof;
(B) 1,2-di(acyloxy)-3-trimethylammoniopropane chloride in which the acyl moiety is derived from c12-c22 fatty acids such as Palm, Tallow, Canola and/or other suitable fatty acids, which can be fractionated and/or hydrogenated, and/or mixtures thereof;
(C) N,N-bis(hydroxyethyl)-N,N-dimethyl ammonium chloride fatty acid esters; N,N-bis(acyl-oxy-ethyl)-N,N-dimethyl ammonium chloride in which the acyl moiety is derived from C12-C22 fatty acids such as Palm, Tallow, Canola and/or other suitable fatty acids, which can be fractionated and/or hydrogenated, and/or mixtures thereof, such as N,N-bis (tallowoyl-oxy-ethyl) N,N-dimethyl ammonium chloride;
(D) esterification products of Fatty Acids with Triethanolamine, quaternized with Dimethyl Sulphate; N,N-bis(acyl-oxy-ethyl)N-(2-hydroxyethyl)-N-methyl ammonium methylsulfate in which the acyl moiety is derived from C12-C22 fatty acids such as Palm, Tallow, Canola and/or other suitable fatty acids, which can be fractionated and/or hydrogenated, and/or mixtures thereof, such as N,N-bis(tallowoyl-oxy-ethyl)N-(2-hydroxyethyl)-N-methyl ammonium methylsulfate;
(E) dicanoladimethylammonium chloride; di(hard)tallowdimethylammonium chloride; dicanoladimethylammonium methylsulfate; 1-methyl-1-stearoylamidoethyl-2-stearoylimidazolinium methylsulfate; 1-tallowylamidoethyl-2-tallowylimidazoline; dipalmylmethyl hydroxyethylammoinum methylsulfate; and/or
(F) mixtures thereof.

Examples of suitable quaternary ammonium ester compound are commercially available from Evonik under the tradename REWOQUAT WE18 and/or REWOQUAT WE20, and from Stepan under the tradename STEPANTEX GA90, STEPANTEX VK90, and/or STEPANTEX VL90A.

It is understood that compositions that comprise a quaternary ammonium ester compound as a fabric conditioning active may further comprise non-quaternized derivatives of such compounds, as well as unreacted reactants (e.g., free fatty acids).

The quaternary ammonium compound can be that used as part of BOUNCE dryer sheets available from The Procter & Gamble Company, Cincinnati, Ohio, USA. The quaternary ammonium compound can be the reaction product of triethanolamine and partially hydrogenated tallow fatty acids quaternized with dimethyl sulfate.

It will be understood that combinations of quaternary ammonium compounds disclosed above are suitable for use in this invention.

The particles, or adjunct particles if used, can comprise from about 10 to about 40% by weight quaternary compound.

The iodine value of a quaternary ammonium compound is the iodine value of the parent fatty acid from which the compound is formed and is defined as the number of grams of iodine which react with 100 grams of parent fatty acid from which the compound is formed.

First, the quaternary ammonium compound is hydrolysed according to the following protocol: 25 g of quaternary ammonium compound is mixed with 50 mL of water and 0.3 mL of sodium hydroxide (50% activity). This mixture is boiled for at least an hour on a hotplate while avoiding that the mixture dries out. After an hour, the mixture is allowed to cool down and the pH is adjusted to neutral (pH between 6 and 8) with sulfuric acid 25% using pH strips or a calibrated pH electrode.

Next the fatty acid is extracted from the mixture via acidified liquid-liquid extraction with hexane or petroleum ether: the sample mixture is diluted with water/ethanol (1:1) to 160 mL in an extraction cylinder, 5 grams of sodium chloride, 0.3 mL of sulfuric acid (25% activity) and 50 mL of hexane are added. The cylinder is stoppered and shaken for at least 1 minute. Next, the cylinder is left to rest until 2 layers are formed. The top layer containing the fatty acid in hexane is transferred to another recipient. The hexane is then evaporated using a hotplate leaving behind the extracted fatty acid.

Next, the iodine value of the parent fatty acid from which the fabric conditioning active is formed is determined following ISO3961:2013. The method for calculating the iodine value of a parent fatty acid comprises dissolving a prescribed amount (from 0.1-3 g) into 15 mL of chloroform. The dissolved parent fatty acid is then reacted with 25 mL of iodine monochloride in acetic acid solution (0.1M). To this, 20 mL of 10% potassium iodide solution and 150 mL deionised water is added. After the addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acid enables the iodine value to be calculated.

### Silicone

The fabric care agent can be a silicone. The composition can comprise from about 0.1% to about 60% of silicone by weight of the composition. Alternatively, the composition can comprise about 3% to about 50%, preferably from about 10% to about 40%, more preferably from about 20% to about 35%, e.g., from about 28% to about 32%, of silicone by weight of the composition.

### Cationic Polymer

The fabric care agent can be a cationic polymer. Cationic polymers can provide the benefit of a deposition aid that helps to deposit, onto the fabric, quaternary ammonium compound and possibly some other benefit agents that are contained in the particles. Optionally, the cationic polymer can be provided as or in an adjunct particle.

The composition can comprise from about 0.5% to about 10% by weight cationic polymer. Optionally, the composition can comprise from about 0.5% to about 5% by weight cationic polymer, or even about 1% to about 5% by weight, or even about 2% to about 4% by weight cationic polymer, or even about 3% by weight cationic polymer.

Non-limiting examples of cationic polymers are cationic or amphoteric, polysaccharides, proteins and synthetic polymers. Cationic polysaccharides include cationic cellulose derivatives, cationic guar gum derivatives, chitosan and its derivatives and cationic starches. Suitable cationic polysaccharides include cationic cellulose ethers, particularly cationic hydroxyethylcellulose and cationic hydroxypropylcellulose.

Cationic polymers including those with the INCI name Polyquaternium-4; Polyquaternium-6; Polyquaternium-7; Polyquaternium-10; Polyquaternium-22; Polyquaternium-67; and mixtures thereof can be suitable. Other suitable polysaccharides include hydroxyethyl cellulose or hydoxypropylcellulose quaternized with glycidyl C₁₂-C₂₂ alkyl dimethyl ammonium chloride. The cationic polymer can be cationic guar gum or cationic locust bean gum. An example of a cationic guar gum is a quaternary ammonium derivative of hydroxypropyl guar. In another aspect, the cationic polymer may be selected from the group consisting of cationic polysaccharides. In one aspect, the cationic polymer may be selected from the group consisting of cationic cellulose ethers, cationic galactomanan, cationic guar gum, cationic starch, and combinations thereof. The cationic polymer can be provided in a powder form. The cationic polymer can be provided in an anhydrous state.

### Fatty Acid

The particles fabric care agent can be fatty acid. The term “fatty acid” is used herein in the broadest sense to include unprotonated or protonated forms of a fatty acid. One skilled in the art will readily appreciate that the pH of an aqueous composition will dictate, in part, whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise).

The fatty acid may include those containing from 12 to 25, from 13 to 22, or even from 16 to 20, total carbon atoms, with the fatty moiety containing from 10 to 22, from 12 to 18, or even from 14 (mid-cut) to 18 carbon atoms.

Mixtures of fatty acids from different fat sources can be used. Branched fatty acids such as isostearic acid are also suitable since they may be more stable with respect to oxidation and the resulting degradation of color and odor quality. The fatty acid may have an iodine value from 0 to 140, from 10 to 120, from 50 to 120 or even from 85 to 105.

The composition can comprise from about 0% to about 40%, optionally from about 1% to about 40%, by weight fatty acid. The fatty acid can be selected from the group consisting of, a saturated fatty acids, unsaturated fatty acid, and mixtures thereof. The fatty acid can be a blend of saturated fatty acids, a blend of unsaturated fatty acids, and mixtures thereof. The fatty acid can be substituted or unsubstituted. The fatty acid can be provided with the quaternary ammonium compound. The fatty acid can have an Iodine Value of zero.

The fatty acid can be selected from the group consisting of stearic acid, palmitic acid, coconut oil, palm kernel oil, stearic acid palmitic acid blend, oleic acid, vegetable oil, partially hydrogenated vegetable oil, and mixtures thereof.

The fatty acid can be Stearic acid CAS No. 57-11-4. The fatty acid can be palmitic acid CAS No. 57-10-3. The fatty acid can be a blend of stearic acid and coconut oil. The fatty acid can be C12 to C22 fatty acid. C12 to C22 fatty acid can have tallow or vegetable origin, can be saturated or unsaturated, can be substituted or unsubstituted.

### Surfactant

The fabric care agent can be an anionic surfactant. More preferably the surfactant comprises a combination of anionic surfactant and nonionic surfactant and most preferably the surfactant is a combination of anionic surfactant and nonionic surfactant.

Typically, the amount of surfactant is present in amount of 0.1 to 15%, more preferably 0.4 to 7% and most preferably 1 to 5% by weight of the composition. The weight ratio of the water-soluble carrier to the surfactant is preferably in amount of 1:1 to 1000:1, more preferably 5:1 to 200:1 and even more preferably 15:1 to 60:1.

Examples of suitable anionic surfactants are the alkyl sulphates, alkyl ether sulphates, soap, alkaryl sulphonates, alkanoyl isethionates, alkyl succinates, alkyl sulphosuccinates, alkyl ether sulphosuccinates, N-alkyl sarcosinates, alkyl phosphates, alkyl ether phosphates, and alkyl ether carboxylic acids and salts thereof, especially their sodium, magnesium, ammonium and mono-, di- and triethanolamine salts. The alkyl and acyl groups generally contain from 8 to 18, preferably from 10 to 16 carbon atoms and may be unsaturated. The alkyl ether sulphates, alkyl ether sulphosuccinates, alkyl ether phosphates and alkyl ether carboxylic acids and salts thereof may contain from 1 to 20 ethylene oxide or propylene oxide units per molecule.

Preferred anionic surfactants comprise alkyl sulfates, alkyl ether sulfates, soap or a mixture thereof. More preferably, anionic surfactants comprise alkyl sulfates, alkyl ether sulfates, or a mixture thereof. These materials have the respective formulae R2OSO3M and R1O (C2H4O) xSO3M, wherein R2 is alkyl or alkenyl of from 8 to 18 carbon atoms, x is an integer having a value of from about 1 to about 10, and M is a cation such as ammonium, alkanolamines, such as triethanolamine, monovalent metals, such as sodium and potassium, and polyvalent metal cations, such as magnesium, and calcium. Most preferably R2 has 12 to 14 carbon atoms, in a linear rather than branched chain.

More preferred surfactants are selected from sodium lauryl sulphate, sodium lauryl ether sulphate or a mixture thereof. Even more preferred anionic surfactants are selected from sodium lauryl sulphate and sodium lauryl ether sulphate(n)EO, (where n is from 1 to 3), and a mixture thereof; still even more preferably sodium lauryl ether sulphate(n)EO, (where n is from 1 to 3); most preferably sodium lauryl ether sulphate(n)EO where n=1.

Typically, the amount of anionic surfactant is present in amount of 0.1 to 12%, more preferably 0.3 to 6% and most preferably 0.6 to 3% by weight of the composition. The weight ratio of the water-soluble carrier to the anionic surfactant is preferably in amount of 1:1 to 2000:1, more preferably 10:1 to 200:1 and even more preferably 25:1 to 100:1.

### Method of Usage

The composition comprising the plurality of particles disclosed herein can be conveniently employed to treat laundry articles. The steps of the process can be to provide such particles comprising the formulation components disclosed herein. A dose of the particles can be placed in a dosing cup. The dosing cup can be the closure of a package containing the particles. The dosing cup can be a detachable and attachable dosing cup that is detachable and attachable to a package containing the particles or to the closure of such package. The dose of the particles in the dosing cup can be dispensed into a washing machine. The step of dispensing the particles in the washing machine can take place by pouring the particles into the washing machine or placing the dosing cup and the particles contained therein into the washing machine.

The process for treating laundry can comprise the steps of providing laundry in a washing machine. The composition can be dispensed into the washing machine. The laundry can be contacted with water. The composition can be dissolved in the water to form a laundry treatment liquor. The laundry can be contacted with the laundry treatment liquor. The laundry can be contacted with water during the wash sub-cycle of the washing machine.

The process can optionally comprise a step of contacting the laundry during the wash sub-cycle with a detergent composition comprising an anionic surfactant. During the wash sub-cycle, the wash basin may be filled or at least partially filled with water. The particles can dissolve into the water to form a wash liquor comprising the components of the particles. Optionally, if a detergent composition is employed, the wash liquor can include the components of the detergent composition and the particles or dissolved particles. The particles can be placed in the wash basin of the washing machine before the laundry is placed in the wash basin of the washing machine. The particles can be placed in the wash basin of the washing machine after the laundry is placed in the wash basin of the washing machine. The particles can be placed in the wash basin prior to filling or partially filling the wash basin with water or after filling of the wash basin with water has commenced. If a detergent composition is employed by the consumer in practicing the process of treating laundry, the detergent composition and particles can be provided from separate packages. For instance, the detergent composition can be a liquid detergent composition provided from a bottle, sachet, water-soluble, dosing cup, dosing ball, or cartridge associated with the washing machine. The particles can be provided from a separate package, by way of non-limiting example, a carton, bottle, water-soluble, dosing cup, sachet, or the like. If the detergent composition is a solid form, such as a powder, water-soluble fibrous substrate, water-soluble sheet, water-soluble film, water-soluble film, water insoluble fibrous web carrying solid detergent composition, the particles can be provided with the solid form detergent composition. For instance, the particles can be provided from a container containing a mixture of the solid detergent composition and the particles. Optionally, the particles can be provided from a pouch formed of a detergent composition that is a water-soluble fibrous substrate, water-soluble sheet, water-soluble film, water-soluble film, water insoluble fibrous web carrying solid detergent composition.

### Production of Particles

For a water-soluble carrier that can be processed conveniently as a melt, the rotoforming process can be used to produce the particles. A mixture of molten water-soluble carrier and the other materials constituting the particles is prepared, for instance in a batch or continuous mixing process. The molten mixture can be pumped to a rotoformer, for instance a Sandvik ROTOFORM 3000 having a 750 mm wide 10 m long belt. The rotoforming apparatus can have a rotating cylinder. The cylinder can have 2 mm diameter apertures set at a 10 mm pitch in the cross machine direction and 9.35 mm pitch in the machine direction. The cylinder can be set at approximately 3 mm above the belt. The belt speed and rotational speed of the cylinder can be set at about 10 m/min. The molten mixture can be passed through the apertures in the rotating cylinder and deposited on a moving conveyor that is provided beneath the rotating cylinder.

The molten mixture can be cooled on the moving conveyor to form a plurality of solid particles. The cooling can be provided by ambient cooling. Optionally the cooling can be provided by spraying the under-side of the conveyor with ambient temperature water or chilled water.

Once the particles are sufficiently coherent, the particles can be transferred from the conveyor to processing equipment downstream of the conveyor for further processing and or packaging.

Optionally, the particles can be provided with inclusions of a gas. Such occlusions of gas, for example air, can help the particles dissolve more quickly in the wash. Occlusions of gas can be provided, by way of nonlimiting example, by injecting gas into the molten precursor material and milling the mixture.

Particles can also be made using other approaches. For instance, granulation or press agglomeration can be appropriate. In granulation, the precursor material containing the constituent materials of the particles is compacted and homogenized by rotating mixing tools and granulated to form particles. For precursor materials that are substantially free of water, a wide variety of sizes of particles can be made.

In press agglomeration, the precursor material containing the constituent materials of the particles is compacted and plasticized under pressure and under the effect of shear forces, homogenized and then discharged from the press agglomeration machine via a forming/shaping process. Press agglomeration techniques include extrusion, roller compacting, pelleting, and tableting.

The precursor material containing the constituent materials of the particles can be delivered to a planetary roll extruder or twin screw extruder having co-rotating or contra-rotating screws. The barrel and the extrusion granulation head can be heated to the desired extrusion temperature. The precursor material containing the constituent materials of the particles can be compacted under pressure, plasticized, extruded in the form of strands through a multiple-bore extrusion die in the extruder head, and sized using a cutting blade. The bore diameter of the of extrusion header can be selected to provide for appropriately sized particles. The extruded particles can be shaped using a spheronizer to provide for particles that have a spherical shape.

Optionally, the extrusion and compression steps may be carried out in a low-pressure extruder, such as a flat die pelleting press, for example as available from Amandus Kahl, Reinbek, Germany. Optionally, the extrusion and compression steps may be carried out in a low pressure extruder, such as a BEXTRUDER, available from Hosokawa Alpine Aktiengesellschaft, Augsburg, Germany.

The particles can be made using roller compacting. In roller compacting the precursor material containing the constituent materials of the particles is introduced between two rollers and rolled under pressure between the two rollers to form a sheet of compactate. The rollers provide a high linear pressure on the precursor material. The rollers can be heated or cooled as desired, depending on the processing characteristics of the precursor material. The sheet of compactate is broken up into small pieces by cutting. The small pieces can be further shaped, for example by using a spheronizer.

### Exemplary Compositions of Particles and Graft Copolymers

Exemplary formulations for particles described herein are set forth in Table 1.

TABLE 1
0Example Particle Formulations (components for which multiple suitable materials
are listed, all permutations of possible formulations are contemplated herein).

| | % by Weight | | | | | | | | | | | |
|---|---|---|---|---|---|---|---|---|---|---|---|---|
| Example | I | II | III | IV | V | VI | VII | VIII | IX | X | XI | XII |
| Water-soluble | 95^{a} | 80^{a} | 80^{b} | 93^{a} | 65^{a} | 77^{a} | 77^{c} | 80^{b} | 80^{a} | 70^{a}; 10^{f} | 40^{a}; 20^{d} | 40^{a}; 20^{e} |
| carrier | | | | | | | | | | | | |
| Nonionic | 5 | 3 | 5 | 5 | 15 | 20 | 10 | 5 | 5 | 7 | 5 | 15 |
| polyester soil | | | | | | | | | | | | |
| release polymer | | | | | | | | | | | | |
| Perfume | — | 15 | 8 | — | 10 | — | — | 5 | 5 | — | 5 | — |
| Encapsulated | — | — | 7 | — | 5 | — | — | 5 | 8 | — | 3 | — |
| perfume ^{j} | | | | | | | | | | | | |
| Enzyme | — | — | — | 2 | 1 | — | — | | 1 | — | — | — |
| Antioxidant | — | — | — | — | — | 3 | — | 2 | 1 | — | 3 | 3 |
| Fatty Acid ⁱ | — | — | — | — | — | — | 8 | — | — | — | 10 | — |
| DEEHMAMS ^{g} | — | — | — | — | — | — | — | — | — | 5 | — | — |
| Cationic | — | — | — | — | — | — | — | — | — | 2 | — | — |
| polymer ^{h} | | | | | | | | | | | | |
| Other Optional | Water, solvents, dyes, other optional ingredients to 100% | | | | | | | | | | | |
| Ingredients | | | | | | | | | | | | |

^{a}Poly(ethylene glycol) 8000 available from Sigma-Aldrich, product number 89510, molecular weight 7000-9000 Da.
^{b}water-soluble carrier 2 is a 65/35 blend by weight of PLURIOL E8000 and PLURIOL E4000 available from BASF, Ludwigshafen, Germany.
^{c}Polyethylene glycol-co-polypropylene glycol, Pluronic F68, Pluronic E6800 from BASF, Ludwigshafen, Germany.
^{d}Maltodextran MALTRIN M180 available from the Grain Processing Group, Muscatine, IA.
^{e}Sodium acetate.
^{f}Fructose.
^{g} One or more of: C16-C18 Unsaturated DEEHMAMS (Diethyl Ester Hydroxyethyl Methyl Ammonium Methyl Sulphate) from EVONIK; DEEDMAC (Di-tallowoylethanolester dimethylammonium chloride), where the fatty acid moieties have an Iodine Value of ~18-22 (e.g., about 20) (approximately 9% by weight ethanol and 3% by weight coconut oil); DEEDMAC (Di-tallowoylethanolester dimethylammonium chloride), where the fatty acid moieties have an Iodine Value of ~18-22 (e.g., 20) (approximately 9% by weight ethanol and 3% by weight coconut oil).
^{h} one or more of: synthetic cationic polymer MERQUAT 280, available from Lubrizol, Wickliffe, Ohio, USA,; SALCARE 7 available from BASF, Ludwigshafen, Germany; cationic hydroxyethyl cellulose having a weight average molecular weight of 400 kDa, a charge density of 0.18, and an average weight percent of nitrogen per anhydroglucose repeat unit of 0.28%; Cationic hydroxyethyl cellulose having a weight average molecular weight of 400 kDa, a charge density of 0.18, and an average weight percent of nitrogen per anhydroglucose repeat unit of 0.28% (SUPRACARE 150 available from Dow Chemical).
ⁱ fatty acid blend of stearic acid and palmitic acid having an Iodine Value of 0.
^{j} perfume accord encapsulates made from aminoplast resins or cross-linked poly(acrylates) optionally with a poly(vinylformamide) coating available from Encapsys, Appleton, WI.

### Carbon Source of Raw Materials

The raw materials for preparation of the composition for this invention can be based on fossil carbon or renewable carbon. Renewable carbon is a carbon source that avoid the use of fossil carbon such as natural gas, coal, petroleum. Typically, renewable carbon is derived from the biomass, carbon capture, or chemical recycling.

Biomass is a renewable carbon source formed through photosynthesis in the presence of sunlight, or chemosynthesis process in the absence of sunlight. In some cases, polymers isolated from biomass can be used directly, or further derivatized to make performance polymers. For example, the use of polysaccharide (such as starch) and derivatized polysaccharide (such as cellulose derivatives, guar derivatives, dextran derivatives) in fabric home care composition are known. In some cases, biomass can be converted into basic chemicals under certain thermal, chemical, or biological conditions. For example, bioethanol can be derived from biomass such as straw, and further convert to biobased polyethylene glycol. Other nonlimiting examples of renewable carbon from biomass include plants (e.g., sugar cane, beets, corn, potatoes, citrus fruit, woody plants, lignocellulosics, hemicellulosics, cellulosic waste), animals, animal fats, fish, bacteria, fungi, plant-based oils, and forestry products. These resources can be naturally occurring, hybrids, or genetically engineered organisms.

Carbon capture is another renewable carbon source which use various process to capture CO₂ or methane from industrial or natural processes, or directly from air (direct capture). Captured methane and CO₂ may be converted into syngas, and/or further convert to basic chemicals, including but not limit to methanol, ethanol, fatty alcohols such as C₁₂/C₁₄ or even C₁₆/C₁₈ alcohols, other alcohols, olefins, alkanes, saturated and unsaturated organic acids, etc. These basic chemicals can used as or further convert to monomers for making transformed to usable chemicals by e.g., catalytic processes, such as the Fischer-Tropsch process or by fermentation by C₁-fixing microorganisms.

Chemical recycling is another renewable carbon source which allow plastics from waste management industry to be recycled and converted into base chemicals and chemical feedstocks. In some cases, waste plastics which cannot be re-used or mechanical recycled are convert to hydrocarbons or basic petrochemicals through gasification, pyrolysis or hydrothermal treatment processes, the hydrocarbons and basic petrochemicals can be further convert into monomers for polymers. In some cases, waste plastics are depolymerized into monomers to make new polymers. It is also possible that waste plastics are depolymerized into oligomers, the oligomers can be used as building blocks to make new polymers. The waste plastic converted by various processes to a waste plastic feedstock for the above materials may either be used alone or in combination with traditional surfactant feedstocks, such as kerosene, polyolefins derived from natural gas, coal, crude oil or even biomass, or waste fat/oil-derived paraffin and olefin, to produce biodegradable surfactants for use in detergents and other industries (thereby providing a benefit to society). Preferably, the surfactant, polymers and other ingredients contains renewable carbon, the Renewable Carbon Index (RCI, a measure of sustainability by dividing the number of carbons derived from renewable sources by the total number of carbons in an active ingredient) of the polymer is above 10%, more preferably above 30%, more preferably above 50%, more preferably above 60%, more preferably between 70% to 100% (including 100%), and most preferably 100%.

### EXAMPLES

### Synthesis of Nonionic Polyester Soil Release Polymer A1:

In a reactor fitted with an overhead stirrer, a distillation bridge and an argon inlet with in-line bubbler, are placed dimethyl terephthalate (3 g, 15.0 mmol), 1,2-propanediol (46.0 g, 600 mmol), mPEG2000 (6.0 g, 3.0 mmol), sodium acetate (0.2 g, 2.5 mmol), tetraisopropyl orthotitanate (0.8 g, 2.8 mmol). The contents of the flask are heated at 170° C. under a stream of argon with constant stirring for 3 hours. Then temperature is increased to 210° C. for an additional hour under argon stream. At that point the reaction mixture has turned to a brownish colour. The pressure is then decreased gradually to 1 mbar over 30 minutes, and the reaction mixture is left at 210° C., at low pressure under constant stirring for 3 hours, allowing to distil off the excess of 1,2-propanediol and to force the reaction equilibrium towards the polycondensation product. The reaction mixture is allowed to return at room temperature, and the solidified polymer is tritured in tetrahydrofuran (150 mL) with sonication. The tetrahydrofuran solution is centrifuged, and the residual solution is filtered to remove residual insoluble material. Filtrate is evaporated and the oily residue is dissolved in tetrahydrofuran (20 mL) and diethyl ether is added slowly until the polymer is fully precipitated. A white solid (6.8 g, Yield: 87%) is isolated after filtration and washed with cold diethyl ether.

¹H NMR (298 K, 400 MHz, CDCl₃): δ_{H} 8.15-8.0 (m, 24H, CH benzene), 5.60-5.20 (2 m, 5H, CH 1,2-propanediol), 4.69-4.20 (m, 10H, CH₂ 1,2-propanediol), 3.65 (br s, 360H, CH₂ PEG), 3.39 (s, 6H, CH₃O-PEG), 1.55-1.10 (m, 15H, CH₃ 1,2-propanediol).

### Molar Ratio Between (i) Ethylene Glycol Moiety Present in the Polyalkylene Glycol Structural Unit (c) to (ii) Terephthalate Moiety Present in the Terephthalate Structural Unit (a):

Molar ratio between (i) ethylene glycol moiety present in the polyalkylene glycol structural unit (c) to (ii) terephthalate moiety present in the terephthalate structural unit (a) can be calculated using the integration of HNMR signals.

The polyester soil release polymer (13 to 15 mg) is dissolved in 0.7 mL of Chloroform-d or DMSO-D6, then transfer into a standard NMR tube. Proton (¹H) NMR spectra were recorded on a Bruker Avance III-HD-400 (400.07 MHz for ¹H), Bruker Neo-400 (400.20 MHz for ¹H), Varian DD2-500 (499.53 MHz for ¹H), Varian VNMRS-600 (599.42 MHz for ¹H), or Varian VNMRS-700 (699.73 MHz for ¹H) spectrometers. Spectra were recorded in commercially available deuterated solvents. ¹H chemical shift values are quoted in ppm relative to tetramethylsilane and coupling constants are given in Hz. The operating temperature of the spectrometers (295 K) was measured using an internal calibration solution of ethylene glycol.

Typically, the chemical shift for CH of terephthalate is at 8.20-8.00, and the chemical shift for CH₂ of PEG is at 4.00-3.30. The exact chemical shift for CH of terephthalate and CH₂ of PEG can have some small shifts depend on the solvent or concentration. When polyester soil release polymers raw materials contain solvents, it may be needed for the solvents to be removed before measuring NMR to avoid the potential overlap of signals. Those of ordinary skill in the art will understand how to do NMR measurement and identify the NMR signals for calculation of molar ratio between (i) ethylene glycol moiety present in the polyalkylene glycol structural unit (c) to (ii) terephthalate moiety present in the terephthalate structural unit (a).

Using nonionic polyester soil release polymer A1 as example, the calculated molar ratio between (i) ethylene glycol moiety present in the polyalkylene glycol structural unit (c) to (ii) terephthalate moiety present in the terephthalate structural unit (a) is 15.0. (360/24=15.0). Nonionic polyester soil release polymer A1 has two mPEG2000 end capping groups, the average total molecular weight of ethylene glycol moiety present in the polyalkylene glycol structural units (c1) and (c2) in polymer A1 is about 4000.

The molar ratio between (i) ethylene glycol moiety present in the polyalkylene glycol structural unit (c) to (ii) terephthalate moiety present in the terephthalate structural unit (a) for inventive nonionic polyester soil release polymer (A1 to A7) and comparative polyester soil release polymer (B1 and B2) are summarized in Table 2.

TABLE 2

| | Trade name | Ratio ^{X} |
|---|---|---|
| Inventive A1 | Not commercial | 15.0 |
| Inventive A2 | TexCare SRN300 | 12.2 |
| Inventive A3 | TexCare SRN100 | 11.9 |
| Inventive A4 | TexCare SRN260 | 13.8 |
| Inventive A5 | Repel-O-Tex crystal | 11.8 |
| Inventive A6 | WeyClean PLN1 | 11.2 |
| Inventive A7 | WeyClean PLN2 | 14.5 |
| Comparative B1 | TexCare SRA300F | 0.8 |
| Comparative B2 | WeylClean PSA1 | 0.9 |

^{X} molar ratio between (i) ethylene glycol moiety present in the polyalkylene glycol structural unit (c) to (ii) terephthalate moiety present in the terephthalate structural unit (a).
Calculated based on NMR measurement.

Dispersion of Polyester Soil Release Polymer into Melted PEG8000.

A plastic cup is added pre-weighted PEG 8000, and the sealed cup is placed in an oven at 70° C. until the PEG 8000 melts. To this melt is added the desired amount of polyester soil release polymer with ambient temperature. The composition is mixed with agitation blade under 70° C. Visual check mixture homogeneity along time.

| | Polyester soil | Dispersion |
|---|---|---|
| | release polymer | in PEG |
| Inventive A2 | TexCare SRN300 | <120 s |
| | | (homogeneous mixture) |
| Comparative B1 | TexCare SRA300F | >600 s |
| | | (undispersed particle |
| | | visually available) |

### Making of Inventive and Comparative Particles.

To prepare small scale batches of particles, a benchtop procedure was used. A plastic cup is added pre-weighted PEG 8000, and the sealed cup is placed in an oven at 70° C. until the PEG 8000 melts. To this melt is added the desired amount of polyester soil release polymer with ambient temperature. The composition is mixed with agitation blade for 10 min under 70° C. The mixed melt is immediately poured onto a silicone mold with 5 mm in diameter, hemispherical indentations and the material is evenly spread with a large metal mixing spatula. The composition mixture is cooled to room temperature for at least 5 minutes to solidify. Once cooled, the particles are removed from the mold and collected for further testing. A list of inventive and comparative particles is made in Table 3.

### Dissolution of Inventive and Comparative Particles.

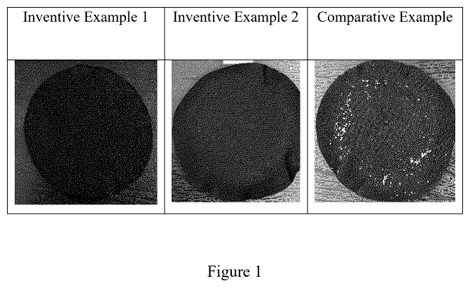

Dissolution was tested by dissolving 0.6 g beads into 500 mL city water (hardness=16 gpg), blended with magnetic stirrer for 10 min. Then the solution was vacuum filtrated by using a piece of black fabric as filter. After filtration, the image of the black fabric (wet) is captured using camera. The results of the images are shown in FIG. 1, and it shows that the Inventive Composition Examples 1 and 2 are fully dissolved while the comparative Composition Example has undesirable dissolution.

TABLE 3
Inventive Composition Examples 1-2 and Comparative Example

| | Inventive | Inventive | Comparative |
|---|---|---|---|
| | Composition | Composition | Composition |
| Ingredient | Example 1 | Example 2 | Example 1 |
| TexCare SRN100 | 5.0% | 0 | 0 |
| TexCare SRN300 | 0 | 5.0% | 0 |
| TexCare SRA300F | 0 | 0 | 5.0% |
| PEG8000 | balance | balance | balance |
| Total | 100% | 100% | 100% |

Cleaning Performance in Combination with Detergent.

Liquid detergent composition E is prepared as a base detergent by traditional means known to those of ordinary skill in the art by mixing the listed ingredients (Table 4).

TABLE 4
Base detergent.

| Ingredients (wt. %) | E |
|---|---|
| AES | 23.95 |
| Nonionic Surfactant | 9.24 |
| LAS | 4.79 |
| Hydrogenated Castor Oil | 2.5 |
| Amine Oxide | 1.596 |
| Enzyme (including Protease, | 1.46 |
| Amylase, Mannanase, Pectawash) | |
| Citric Acid | 1.11 |
| Monoethanolamine | 1.08 |
| Preservative | 1.0673 |
| Ethanol | 0.8 |
| Perfume | 0.739 |
| Chelant | 0.52 |
| Caustic (NaOH) | 0.46 |
| Sodium Cumene Sulfonate | 0.22 |
| Suds Suppressor | 0.116 |
| Ethanolamine | 0.055 |
| Dye | 0.0035 |
| Water/Minors | Balance |

Chelant = DETA + GLDA
Perfume = Free perfume + PMC (Perfume Micro Capsule)

Cleaning benefit is evaluated using automatic tergotometer. Test stains used for the cleaning test is burnt butter on polycotton (burnt butter ex Equest, polycotton is 50/50 polyester/cotton). Other stains can also be used, such as: Dust Sebum on polycotton ex CFT, Highly Discriminating Sebum on polycotton ex CFT.

The stains are analyzed using Image Analysis System for Laundry stain removal testing before and after the wash.

SBL2004 test soil strips supplied by WFK Testgewebe GmbH are used to simulate consumer soil levels (mix of body soil, food, dirt etc.). Every 1 SBL2004 strip is loaded with 8 g soil. The SBL2004 test soil strips were cut into 6×6 cm squares for use in the test. Additional ballast (background fabric swatches) is also used to simulate a fabric load and provide mechanical energy during the real laundry process. Ballast loads are comprised of knitted cotton swatches at 6×6 cm size.

The desired amount of base detergent, polyester soil release polymer stock solution, and composition of this invention are dosed into 1 L water (at defined hardness) in each tergotometer pot. 60 total grams of fabrics including stains (2 internal replicates of each stain in each pot), defined amount of 6×6 cm SBL2004 and ballast are washed and rinsed in the tergotometer pot under defined conditions. The test is repeated 4 times (4 external replicates).

Fabrics are then dried overnight under humidity and temperature control (50% RH, 20±2° C.), then stains are measured again using Image Analysis System for Laundry stain removal testing.

Stain Removal Index (SRI) are automatically calculated from the L, a, b values using the formula shown below Table 5. The higher the SRI, the better the stain removal.

$$SRI = 100 * ( ( Δ {E}_{b} - Δ {E}_{a} ) / Δ {E}_{b} )$$

$$Δ {E}_{b} = √ ( {( {L}_{c} - {L}_{b} )}^{2} + {( {a}_{c} - {a}_{b} )}^{2} + {( {b}_{c} - {b}_{b} )}^{2} )$$

$$Δ {E}_{a} = √ ( {( {L}_{c} - {L}_{a} )}^{2} + {( {a}_{c} - {a}_{a} )}^{2} + {( {b}_{c} - {b}_{a} )}^{2} )$$

Subscript ‘b’ denotes data for the stain before washing.
Subscript ‘a’ denotes data for the stain after washing.
Subscript ‘c’ denotes data for the unstained fabric.
   The following test Examples in Table 5 are tested for cleaning, with result summarized in Table 5.

TABLE 5

| | Materials in wash pot | | | Cleaning | |
|---|---|---|---|---|---|
| | Base | SRP added directly | SRP provided via | SRI | |
| Test | detergent | into wash solution | particle of Table 3 | (Burnt | |
| samples | (ppm) | (ppm) ^{c} | (ppm) | butter) * | Difference |
| 1 | 1010 | 24 (TexCare | 0 | 65.8 AB | −2.4 |
| | | SRN300) | | | |
| 2 | 1010 | 0 | 24 (TexCare | 63.4 B | |
| | | | SRN300) ^{a} | | |
| 3 | 1010 | 24 (TexCare | 0 | 69.2 A | −10.3^{s} |
| | | SRA300) | | | |
| 4 | 1010 | 0 | 24 (TexCare | 58.9 C | |
| | | | SRA300) ^{b} | | |

Washing condition: 17-minute wash cycle (temperature: 27 C.); 5-minute rinse cycle (temperature: 15 C.); 7-8 gpg water hardness.
^{a} provided via Inventive Composition Example 2 (Table 3).
^{b} provided via Comparative Composition Example 1 (Table 3).
^{s}statically significant difference.
* Levels not connected by same letter are significantly different.
^{c} SRP is added via fresh prepared stock solution into wash pot, to avoid potential hydrolysis if formulated into base detergent.

The results show at least that,
Sample 1 vs Sample 3: when delivered SRP directly into wash solution, TexCare SRN300 (inventive SRP) and TexCare SRA300 (comparative SRP) show similar performance, suggesting both polymers are effective soil release polymers.
Sample 2 vs Sample 4: when delivered via particles of particle of Table 3, TexCare SRN300 delivered significant higher performance vs TexCare SRA300.
Sample 1 vs Sample 2: different ways of adding TexCare SRN300 (directly into wash solution vs via particle) has no significant impact on its cleaning performance, i.e., maintaining parity cleaning performance.
Sample 3 vs Sample 4: different ways of adding TexCare SRA300 (directly into wash solution vs via particle) has significant impact on its cleaning performance. The cleaning performance of TexCare SRA300 delivered via particle is significantly lower.

The examples below are intended to illustrate the invention in detail without, however, limiting it thereto. Unless explicitly stated otherwise, all percentages given are percentages by weight (% by wt. or wt.-%, or wt. %).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A particle comprising:
from 25% to 99%, by weight of the particle, a polyalkylene glycol water-soluble carrier; and
from 1.0% to 75%, by weight of the particle, a nonionic polyester soil release polymer;
wherein:
the nonionic polyester soil release polymer comprises:
(a) at least one terephthalate structural unit,
(b) at least one alkylene glycol structural unit,
(c) at least one polyalkylene glycol structural unit comprising at least one ethylene glycol moiety;
the molar ratio between (i) ethylene glycol moiety present in the polyalkylene glycol structural unit (c) to (ii) terephthalate moiety present in the terephthalate structural unit (a) is at least 5.0;
the particle has a mass of from 5.0 mg to 1.0 g;
the particle has a longest dimension of at least 3.0 mm; and
the particle has an aspect ratio of from more than 1.1 to less than 5.0.

2. The particle of claim 1, wherein the polyalkylene glycol water-soluble carrier comprises polyethylene glycol having a weight average molecular weight from 2000 to 20000 Da.

3. The particle of claim 1, wherein the molar ratio between (i) ethylene glycol moiety present in the polyalkylene glycol structural unit (c) to (ii) terephthalate moiety present in the terephthalate structural unit (a) ranges from 8 to 25.

4. The particle of claim 1, wherein the nonionic polyester soil release polymer comprises at least one terephthalate structural unit (a), at least one alkylene glycol structural unit (b), at least one polyalkylene glycol structural unit selected from a first polyalkylene glycol structural unit (c1) and/or a second polyalkylene glycol structural unit (c2), with the structures of (a), (b), (c1) and (c2) as shown below: 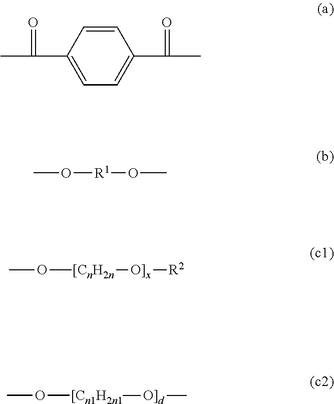
wherein,
R¹ is a linear or branched alkylene group represented by the formula (CₘH₂ₘ) wherein m is an integer from 2 to 12,
R² is a linear or branched C₁-C₃₀ alkyl group, a cycloalkyl group with from 5 to 9 carbon atoms or a C₆-C₃₀ arylalkyl group,
n is independently selected from an integer from 2 to 12,
x is, based on a molar average, a number from 2 to 200,
n1 is independently selected from an integer from 2 to 12,
d is, based on molar average, a number from 2 to 200,
wherein the polyalkylene glycol structural units (c1) and/or (c2) comprises at least one ethylene glycol moiety,
wherein the molar ratio between (i) ethylene glycol moiety present in the polyalkylene glycol structural units (c1) and (c2) to (ii) terephthalate moiety present in the terephthalate structural unit (a) ranges from 10 to 20.

5. The particle of claim 4, wherein the alkylene glycol structural unit (b) has a structure such that,
R¹ is a linear or branched alkylene group represented by the formula (CₘH₂ₘ) wherein m is each independent an integer of from 2 or 3.

6. The particle of claim 4, wherein the first polyalkylene glycol structural unit (c1) has a structure such that,
x is, based on a molar average, a number of from 10 to 180.

7. The particle of claim 4, wherein the second polyalkylene glycol structural unit (c2) has a structure such that,
n1 is independently selected from an integer of from 2 to 4,
d is, based on a molar average, a number of from 10 to 150.

8. The particle of claim 4, wherein the second polyalkylene glycol structural unit (c2) has a structure: 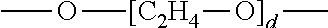
wherein d is, based on a molar average, a number of from 20 to 120.

9. The particle of claim 4, wherein the first polyalkylene glycol structural unit (c1) has a structure such that,
R² is a linear C1-C₆ alkyl group and even more preferably CH₃,
n is an integer of from 2 to 4, and
x is, based on a molar average, a number of from 15 to 150.

10. The particle of claim 4, wherein the average total molecular weight of ethylene glycol moiety present in the polyalkylene glycol structural units (c1) and (c2) in the nonionic polyester soil release polymer molecule, is from 1000 to 12000.

11. The particle of claim 1, wherein the particle further comprises an additional water-soluble carrier selected from sodium chloride, sodium sulfate, sodium monohydrogen carbonate, inorganic alkaline earth metal salt, sodium acetate, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, and combinations thereof.

12. The particle of claim 1, wherein the particle further comprises from 0.1 wt. % to 20.0 wt. % of one or more perfume ingredients, wherein the perfume ingredients are selected from free perfumes, pro-perfumes, perfume capsules, and any combinations thereof.

13. The particle of claim 1, wherein the particle further comprises from 0.5 wt. % to 15.0 wt. % of one or more perfume ingredients, wherein the perfume ingredients are selected from free perfumes, pro-perfumes, perfume capsules, and any combinations thereof.

14. A composition comprising the particle of claim 1, wherein the particle is present in the range from 0.1% to 99% by weight of the composition.

15. The composition of claim 13, further comprising a fabric care active agent.

16. A process for making the particle of claim 1, comprising the steps of:
providing a mixture of molten polyalkylene glycol water-soluble carrier, a nonionic polyester soil release polymer and the other optional materials; and
cooling down the molten mixture on the moving conveyor to form a plurality of solid particles.
